(19) United States
(12) Patent Application Publication
(10) Pub. No.: US 2015/0370478 A1
(43) Pub. Date: Dec. 24, 2015

(54) INPUT SUPPORT SYSTEM, INPUT SUPPORT METHOD AND INPUT SUPPORT PROGRAM

(71) Applicant: NEC SOLUTIION INNOVATORS, LTD., Koto-ku, Tokyo (JP)

(72) Inventors: Yuzuru OKAJIMA, Tokyo (JP); Kosuke YAMAMOTO, Tokyo (JP)

(73) Assignee: NEC Solution Innovators, Ltd., Koto-ku, Tokyo (JP)

(21) Appl. No.: 14/761,119

(22) PCT Filed: Sep. 5, 2013
(86) PCT No.: PCT/JP2013/005267

§ 371 Date: Jul. 15, 2015

(30) Foreign Application Priority Data
Jan. 22, 2013 (JP) 2013-009571

(51) Int. Cl. G06F 3/0489; G06F 3/0484

(52) U.S. Cl. CPC G06F 3/04895; G06F 3/04842

(57) ABSTRACT

An input support system includes: input log storage means for storing, as an input log, information input to a target input box in the past; type-specific correct answer input storage means for storing information indicative of correct input for each type of information; and type estimation means for estimating to which type-specific field, as a field for each type stored in the type-specific correct answer input storage means, the type of information to be input to the input box corresponds, based on the input log stored in the input log storage means and information indicative of type-specific correct input stored in the type-specific correct answer input storage means.

### TECHNICAL FIELD

The present invention relates to an input support system, an input support method, and an input support program for supporting information input to a predetermined input box by a user.

### BACKGROUND ART

When a user is required to enter information into a certain input box, there are various techniques for supporting input of the information. For example, there are known a technique for converting information input by a user into information of a type to be included in the input box to do re-input, and a technique for determining whether information input by a user is correct or not.

Patent Literature (PTL) 1 discloses a technique in which, when a facility name is input in a text box, it is converted to an address and input.

### CITATION LIST

### Patent Literature

PTL 1: Japanese Patent Application Laid-Open No. H11-248472

### SUMMARY OF INVENTION

### Technical Problem

However, in the method described in PTL 1, there is a need to specify a type of data that can be input to an entry box in advance, and it is complicated to make such specification for all entry boxes in advance. Further, depending on the entry box, it may be difficult to properly specify a type of data that can be input.

Therefore, it is an object of the present invention to provide an input support system, an input support method, and an input support program capable of supporting a user to enter information to various input boxes without specifying, in advance, a type of data that can be input.

### Solution to Problem

The input support system according to the present invention is including: input log storage means for storing, as an input log, information input to a target input box in the past; type-specific correct answer input storage means for storing information indicative of correct input for each type of information; and type estimation means for estimating to which type-specific field, as a field for each type stored in the type-specific correct answer input storage means, the type of information to be input to the input box corresponds, based on the input log stored in the input log storage means and information indicative of type-specific correct input stored in the type-specific correct answer input storage means.

Further, the input support method according to the present invention is including: causing input log storage means to store, as an input log, information input to a target input box in the past; causing type-specific correct answer input storage means to store information indicative of correct input for each type of information; and causing an information processing apparatus to estimate to which type-specific field, as a field for each type stored in the type-specific correct answer input storage means, the type of information to be input to the input box corresponds, based on the input log stored in the input log storage means and information indicative of type-specific correct input stored in the type-specific correct answer input storage means.

Further, the input support program according to the present invention is an input support program applied to an information processing apparatus accessible to input log storage means for storing, as an input log, information input to a target input box in the past, and type-specific correct answer input storage means for storing information indicative of correct input for each type of information, the program causing a computer to execute a process of estimating to which type-specific field, as a field for each type stored in the type-specific correct answer input storage means, the type of information to be input to the input box corresponds, based on the input log stored in the input log storage means and information indicative of type-specific correct input stored in the type-specific correct answer input storage means.

### Advantageous Effect of Invention

According to the present invention, a user can be supported to enter information to various input boxes without specifying, in advance, a type of data that can be input.

### BRIEF DESCRIPTION OF DRAWINGS

FIG. 1 It depicts a block diagram depicting a configuration example of an input support system of a first exemplary embodiment.

FIG. 2 It depicts a flowchart depicting an example of operation of the first exemplary embodiment.

FIG. 3 It depicts an explanatory diagram depicting an example of information stored in a type-specific correct answer input DB 102.

FIG. 4 It depicts an explanatory diagram depicting an example of an input log stored in input log storage means 101.

FIG. 5 It depicts an explanatory diagram depicting an example of an estimation result of a type of input information.

FIG. 6 It depicts an explanatory diagram depicting another example of information stored in the type-specific correct answer input DB 102.

FIG. 7 It depicts an explanatory diagram depicting another example of type-of-input information estimation processing.

FIG. 8 It depicts an explanatory diagram depicting an example of giving a score to each record of a type-specific field determined to be an estimation result.

FIG. 9 It depicts an explanatory diagram depicting still another example of information stored in the type-specific correct answer input DB 102.

FIG. 10 It depicts an explanatory diagram depicting still another example of the type-of-input information estimation processing.

FIG. 11 It depicts an explanatory diagram depicting an example of information stored in the type-specific correct answer input DB 102 and an example of the type-of-input information estimation processing.

FIG. 12 It depicts an explanatory diagram depicting an example of the type-specific correct answer input DB 102 on which clustering is performed, and an example of the type-of-input information estimation processing.

FIG. 13 It depicts an explanatory diagram depicting an example of type-of-input information estimation processing using an input log with levels of effectiveness.

FIG. 14 It depicts an explanatory diagram depicting an example of type-of-input information estimation processing using an input log with information on persons who entered data.

FIG. 15 It depicts a block diagram depicting a configuration example of an input support system of a second exemplary embodiment.

FIG. 16 It depicts a flowchart depicting an example of operation of the input support system of the second exemplary embodiment.

FIG. 17 It depicts an explanatory diagram depicting error messages.

FIG. 18 It depicts an explanatory diagram depicting an error determination.

FIG. 19 It depicts an explanatory diagram depicting an error determination.

FIG. 20 It depicts an explanatory diagram depicting error messages.

FIG. 21 It depicts an explanatory diagram depicting an error determination.

FIG. 22 It depicts an explanatory diagram depicting an error determination.

FIG. 23 It depicts an explanatory diagram depicting an error determination.

FIG. 24 It depicts an explanatory diagram depicting error messages.

FIG. 25 It depicts an explanatory diagram depicting an error determination.

FIG. 26 It depicts an explanatory diagram depicting an error determination.

FIG. 27 It depicts an explanatory diagram depicting an error message.

FIG. 28 It depicts a block diagram depicting a configuration example of an input support system of a third exemplary embodiment.

FIG. 29 It depicts a flowchart depicting an example of operation of the input support system of the third exemplary embodiment.

FIG. 30 It depicts an explanatory diagram depicting prediction processing.

FIG. 31 It depicts an explanatory diagram depicting prediction processing.

FIG. 32 It depicts an explanatory diagram depicting prediction processing.

FIG. 33 It depicts an explanatory diagram depicting prediction processing.

FIG. 34 It depicts an explanatory diagram depicting prediction processing.

FIG. 35 It depicts an explanatory diagram depicting prediction processing.

FIG. 36 It depicts an explanatory diagram depicting prediction processing.

### DESCRIPTION OF EMBODIMENTS

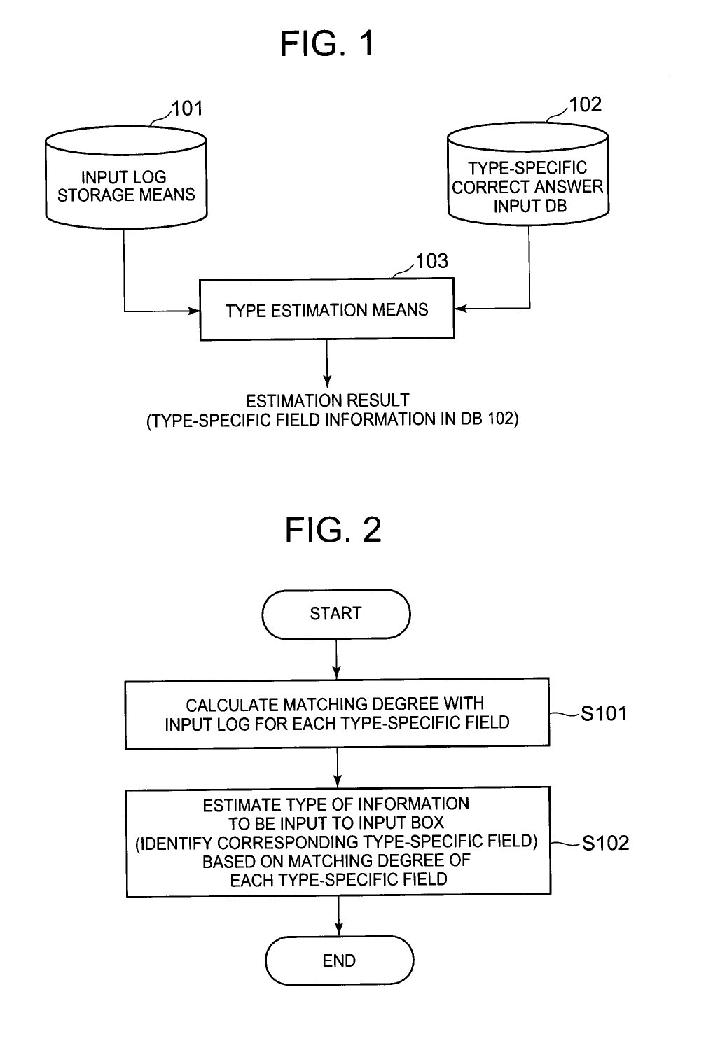

Exemplary embodiments of the present invention will be described below with reference to the accompanying drawings. FIG. 1 is a block diagram depicting a configuration example of an input support system of a first exemplary embodiment. The input support system depicted in FIG. 1 includes input log storage means 101, type-specific correct answer input storage means 102, and type estimation means 103.

The input log storage means 101 stores, as an input log, information input to an associated input box in the past. Note that, in the input log storage means 101, information converted to correct information in the associated input box as a result of input support may be stored as an input log.

In the type-specific correct answer input storage means 102 (hereinafter called the type-specific correct answer input DB 102), information indicative of the correct input is stored for each type of information. For example, the information indicative of type-specific correct input is examples of input information corresponding to the type or a list of candidates, an input format indicative of a correct representation form, or the like. When a data set such as examples of input information, a list of candidates, or the like is used as the information indicative of type-specific correct input, it is preferred that respective data in the data set should be homogeneous data in terms of the type representation method. In other words, it is preferred that respective data in the data set should be data in which the same representation method is adopted for the corresponding type.

Although the contents and number of types to be held in the type-specific correct answer input DB 102 are optional, it is preferred to contain a type of information desired by the system to be input to the target input box. For example, in the type-specific correct answer input DB 102, information indicative of correct input for a type that tends to be input to an input box may be preregistered, or information input to an associated input box on a trial basis or the like can also be registered as one example. A database or the like that is also used in another system, such as a database of information on persons who belong to an organization or a database of information on company's products, can also be used as the type-specific correct answer input DB 102. Further, an input log acquired in another system can be used as information indicative of correct input of a certain type.

The type estimation means 103 estimates the type of information to be input to a target input box based on the input log stored in the input log storage means 101 and information indicative of type-specific correct input stored in the type-specific correct answer input DB 102. More specifically, the type estimation means 103 estimates to which field for each type (hereinafter called type-specific field) stored in the type-specific correct answer input DB 102 the type of information to be input to the input box corresponds. Here, the field means a set of information with a specific label attached and stored in the storage means, or a storage area storing the set of information. Therefore, the type estimation means 103 does not need to identify, as the estimation result of the type of information to be input to the target input box, what is the specific content of the type. As a result of the estimation, when determining that the type does not correspond to any of type-specific fields stored in the type-specific correct answer input DB 102, the type estimation means 103 may set the estimation result as type unknown.

For example, the type estimation means 103 may calculate a degree of matching of each type-specific field stored in the type-specific correct answer input DB 102 with an input log, i.e., past input information stored in the input log storage means 101 to estimate, as the type of information to be input to the input box, a type-specific field whose matching degree is larger than or equal to a predetermined threshold, or takes the largest value. The matching degree may be, for example, quantified based on the result of a determination for each type-specific field stored in the type-specific correct answer input DB 102 as to whether each piece of past input information stored as an input log matches an input format registered in the type-specific field, or a determination of whether the past input information matches each piece of information included in examples of input information or a list of candidates. For example, the type estimation means 103 may calculate, for each type-specific field, the number of matched input log records to set the number (hereinafter called the number of matched log records) as the matching degree. Further, for example, the type estimation means 103 may set, as the matching degree, the ratio of the number of matched log records to the total number of input log records.

In the exemplary embodiment, for example, the input log storage means 101 and the type-specific correct answer input DB 102 are realized by storage devices such as databases. Further, for example, the type estimation means 103 is implemented by an information processing apparatus operating according to a CPU program or the like. Note that the input support system itself may not necessarily include the input log storage means 101 and the type-specific correct answer input DB 102 as long as the type estimation means 103 is accessible thereto.

FIG. 2 is a flowchart depicting an example of operation of the exemplary embodiment. Note that FIG. 2 is a flowchart depicting, among the operations of the exemplary embodiment, an example of a processing flow of type-of-input information estimation processing performed by the type estimation means 103. As depicted in FIG. 2, for example, when requested to estimate the type of input information, the type estimation means 103 calculates, for each type-specific field in the type-specific correct answer input DB 102, a matching degree with an input log based on the input log for an input box to be estimated and stored in the input log storage means 101 and information indicative of type-specific correct input stored in the type-specific correct answer input DB 102 (step S101). Then, the type estimation means 103 identifies a type-specific field determined to be the estimation result based on the calculated matching degree of each type-specific field (step S102). Note that the type-of-input information estimation processing may be, for example, performed in initialization processing at the time of introduction of the system, or performed periodically during the operation of the system.

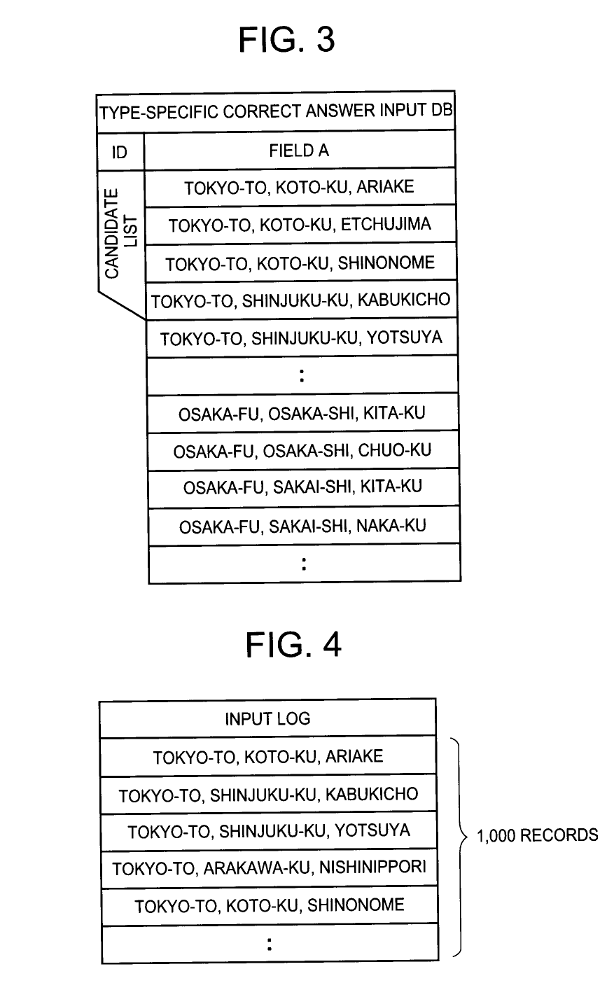

FIG. 3 is an explanatory diagram depicting an example of information stored in the type-specific correct answer input DB 102. As depicted in FIG. 3, information indicative of correct input may be registered for only one type in the type-specific correct answer input DB 102. Note that FIG. 3 depicts an example of the type-specific correct answer input DB 102 having one type-specific field to which a field name (identifier) as “field A” is given. FIG. 3 also depicts an example in which a list of candidates for input information corresponding to the type is registered as information indicative of correct input. The “field A” in this example is an example of a type-specific field in which the type of input information is “address.”

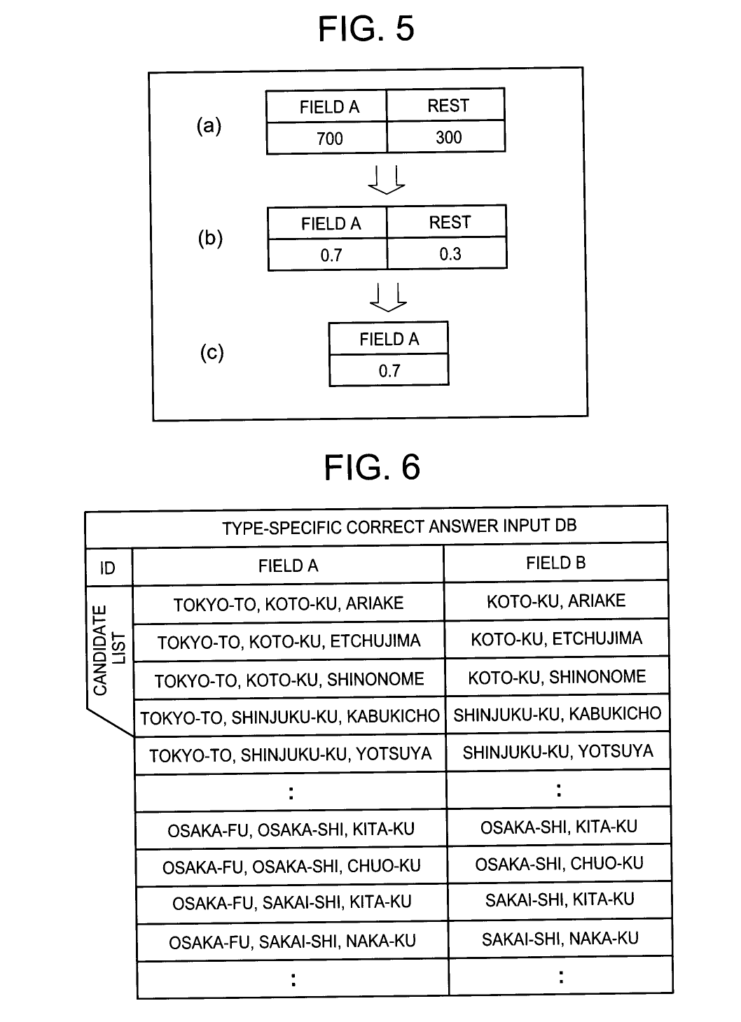

FIG. 4 is an explanatory diagram depicting an example of an input log stored in the input log storage means 101. FIG. 5 is an explanatory diagram depicting an example of an estimation result of the type of input information. Note that the example depicted in FIG. 5 is an example when type-of-input information estimation processing is performed based on the example of the type-specific correct answer input DB 102 depicted in FIG. 3 and the example of the input log depicted in FIG. 4. For example, when a list of candidates is registered in the type-specific correct answer input DB 102 as information indicative of correct input information, the type estimation means 103 may compare the content of each record of the input log (past input information) with the content of each candidate contained in the type-specific field to calculate the number of matched log records for each type-specific field in order to calculate a matching degree based thereon.

Specifically, the type estimation means 103 identifies to which candidate contained in the type-specific field the content of each record of the input log corresponds. The type estimation means 103 may count, for each type-specific field, the number of matched input log records to calculate a matching degree based on the result. The type estimation means 103 may use any of the following methods to determine whether the content of each record of the input log corresponds to each candidate contained in the type-specific field. For example, the type estimation means 103 may determine whether both formats match each other. The type estimation means 103 may also handle each piece of information as character string information to determine whether both exactly match each other. Further, the type estimation means 103 may determine whether the beginning of a candidate character string as the candidate content matches that of a past input character string as the content of a log record. In the case of a forward match, the type estimation means 103 may make a determination based on whether the ratio of the number of matched characters in the past input character string to the number of characters in the candidate character string is a predetermined value or more, or the like.

Further, for example, when examples of input information are registered in the type-specific correct answer input DB 102 as information indicative of correct input information, the type estimation means 103 may compare the content of each record of the input log (past input information) with the content of each example contained in the type-specific field. Then, when the similarity between both character strings is predetermined value or more, the type estimation means 103 may determine that both match and include the result in the number of matched log records. The similarity between character strings may be calculated by using edit distance, information distance vectorized using an n-gram, or the like. Further, the type estimation means 103 may use a weighted distance to change the degree of importance depending on the character position such as to give a weight to matching between first character strings.

When matches are determined in two or more type-specific fields, the type estimation means 103 may count the matches as the number of matches of each of the fields. Further, when forward matching or the like is used, the type estimation means 103 may count, as the number of matched log records, matches in only a field with a larger ratio of the number of matched characters or with a closer distance indicative of the similarity between character strings.

As a result of comparison between the example of the type-specific correct answer input DB 102 depicted in FIG. 3 and the example of the input log depicted in FIG. 4, it is depicted in FIG. 5(a) that the number of input log records that match candidates in the “field A” is 700 and the “rest,” i.e., the number of input log records that do not match any of the candidates in the type-specific field is 300. The type estimation means 103 may use the number of matched log records in each type-specific field as mentioned above as the matching degree of the type-specific field. Here, the type estimation means 103 may use the number of log records that do not match any candidate of the type-specific field to determine whether to set type unknown.

Further, for example, the type estimation means 103 may calculate a matching ratio to the total number of input log records (1,000 records) based on the number of matched log records to set it as the matching degree. In other words, the type estimation means 103 may set, as the matching degree, a value obtained by dividing the number of matched input log records by the total number of input log records used for the determination. FIG. 5(b) depicts an example of calculation results of matching degrees when the matching ratios are used as the matching degrees.

Based on the matching degree of each type-specific field calculated as mentioned above, the type estimation means 103 estimates the type of information the input log of which is collected and which is to be input to the input box. In the example, as depicted in FIG. 5(b), the matching degree with “field A” is 0.7 and the matching degree with the “rest” is 0.3. Therefore, as the estimation result, the type estimation means 103 may identify the “field A” as a type-specific field corresponding to the type of information to be input to the input box (see FIG. 5(c)). Assuming here that the matching ratio of the “rest” takes the largest value, the type estimation means 103 may set the estimation result as no corresponding field, i.e., as type unknown.

FIG. 6 is an explanatory diagram depicting another example of information stored in the type-specific correct answer input DB 102. As depicted in FIG. 6, the type-specific correct answer input DB 102 may store those in multiple description formats for the same entry as different type-specific fields. FIG. 6 depicts an example of the type-specific correct answer input DB 102 having a type-specific field to which a field name of “field A” is given and a type-specific field to which a field name of “field B” is given. In the example, information groups (lists of candidates) representing “addresses” are registered in both the “field A” and the “field B.” More specifically, a list of candidates for information as “addresses starting with the name of a prefecture” is registered in the “field A,” and a list of candidates for information as “addresses that do not include the name of a prefecture” is registered in the “field B.” In the example depicted in FIG. 6, both pieces of information registered in the same record of the “field A” and the “field B” indicate the same address as each other. In other words, respective records in the type-specific fields are associated with each other. However, respective records in the type-specific fields do not necessarily have to be associated with each other.

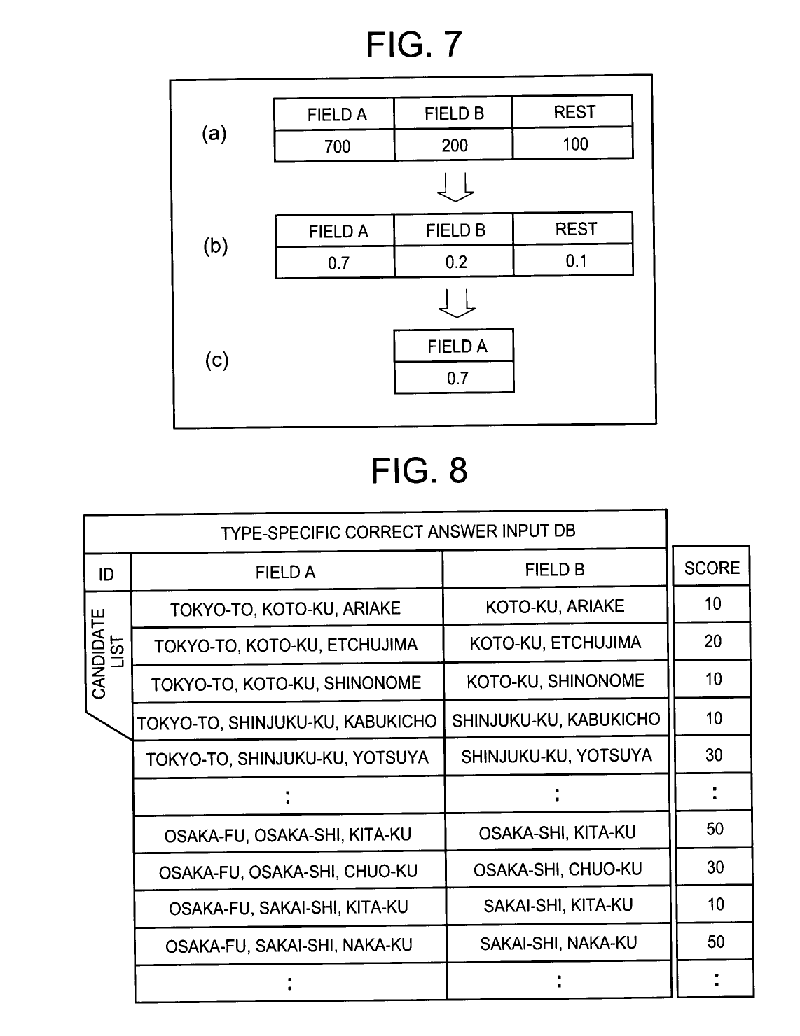

FIG. 7 is an explanatory diagram depicting another example of type-of-input information estimation processing. Note that the example depicted in FIG. 7 is an example when type estimation processing is performed based on the example of the type-specific correct answer input DB 102 depicted in FIG. 6 and the example of the input log depicted in FIG. 4. As depicted in FIG. 7(a), it is assumed that, as a result of comparison between the information in the type-specific fields and the input log, the number of matched log records is 700 in the “field A,” the number of matched log records is 200 in the “field B,” and the “rest,” i.e., the number of log records that do not match the candidates in either type-specific field is 100. In such a case, as depicted in FIG. 7(b), the type estimation means 103 may calculate a matching ratio to the total number of input log records (1,000 records) based on the number of matched log records, and set the matching degree of the “field A” to 0.7, the matching degree of the “field B” to 0.2, and the matching degree of the “rest” to 0.1. From the above results, it is depicted in FIG. 7(c) that the “field A” is identified as a type-specific field corresponding to the type of the input box to be estimated.

As depicted in FIG. 8, as a result of the estimation processing for the type of the input box, the type estimation means 103 may calculate a score based on the number of matches with the input log, for each record of a type-specific field identified to correspond to the type of the input box to be estimated. Then, the type estimation means 103 may cause the type-specific correct answer input DB 102 to hold the calculated score, or output it together with the estimation result. Here, the score of each record is not particularly limited as long as it is a value based on the degree of matching with the input log. The score of each record may be, for example, the number of matched log records itself, or a matching ratio calculated based thereon. The score of each record may be calculated afresh in each estimation processing, or be a cumulative total value of scores calculated in the past.

If such a record-specific score is provided together with the estimation result, finer input support is possible such as to be used as a barometer when subsequent processing means recommends an input candidate.

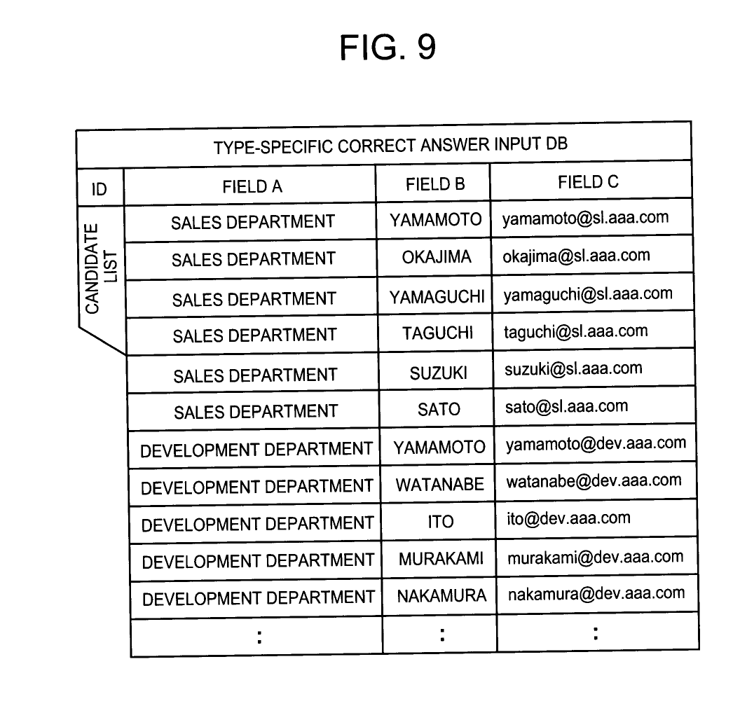

FIG. 9 is an explanatory diagram depicting still another example of information stored in the type-specific correct answer input DB 102. As depicted in FIG. 9, multiple type-specific fields respectively associated with different entries may be registered in the type-specific correct answer input DB 102. FIG. 9 depicts an example of the type-specific correct answer input DB 102 having three type-specific fields “field A,” “field B,” and “field C.” In the example, an information group (a list of candidates in the example) representing “department” is registered in the “field A.” In the “field B,” information group (a list of candidates in the example) representing “family name” is registered. In the “field C,” an information group (a list of candidates in the example) representing “e-mail address” is registered. Thus, the type-specific correct answer input DB 102 may hold multiple type-specific fields associated with different entries, respectively (“department,” “family name,” “e-mail address,” and the like). Further, in the example depicted in FIG. 9, respective elements in respective type-specific fields are associated with one another between respective records. In other words, information on the same target is registered on records located in the same line. However, such an association between records does not have to be made.

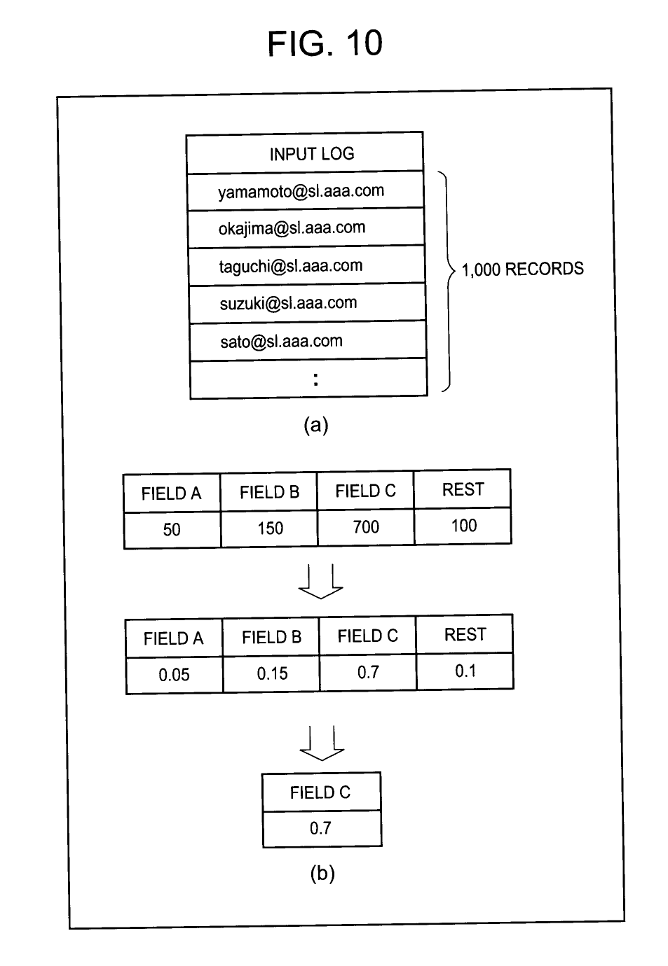

FIG. 10 is an explanatory diagram depicting an example when the type-of-input information estimation processing is performed using the information in the type-specific correct answer input DB 102 depicted in FIG. 9. For example, suppose that input information (for example, 1,000 records) depicted in FIG. 10(a) is stored as an input log. FIG. 10(b) depicts the number of matched log records in each type-specific field, the matching ratio, and the estimation result obtained as a result of comparison between the content of each record of such an input log (past input information) and the content of each record (a list of candidates for input information) included in each type-specific field inside the type-specific correct answer input DB 102 depicted in FIG. 9. Specifically, FIG. 10(b) depicts that the number of matched log records in the “field A” is 50, the number of matched log records in the “field B” is 150, the number of matched log records in the “field C” is 700, and the number of matched log records in the “rest” is 100. Further, FIG. 10(b) depicts that the matching degrees calculated based on the number of matched log records are 0.05 in the “field A,” 0.15 in the “field B,” 0.7 in the “field C,” and 0.1 in the “rest,” and under the condition, the “field C” having the highest matching degree is set as the estimation result.

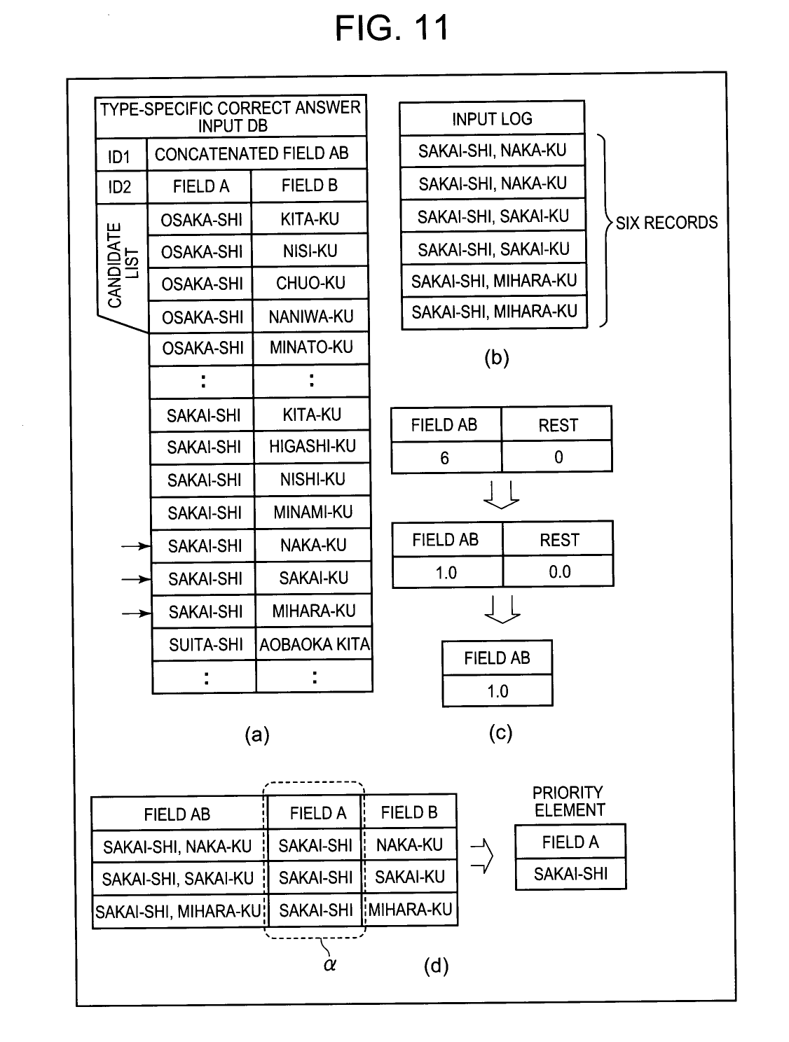

FIG. 11 is an explanatory diagram depicting an example of information stored in the type-specific correct answer input DB 102 and an example of the type-of-input information estimation processing, where FIG. 11(a) is an explanatory diagram depicting yet another example of information stored in the type-specific correct answer input DB 102. As depicted in FIG. 11(a), the type-specific correct answer input DB 102 may be to register multiple type-specific fields as one concatenated type-specific field such as to concatenate type-specific fields in which information groups different in granularity are registered and register the type-specific fields as one concatenated type-specific field. In the example depicted in FIG. 11(a), pieces of information obtained by dividing predetermined information (information indicative of addresses in the example) are registered in the “field A” and the “field B.” In the example, it is assumed that the granularity of information is larger in the “field A.”

In such a case, the type estimation means 103 may handle the concatenated field as one type-specific field to make a determination of matching with the input log. In the example depicted in FIG. 11(a), the type estimation means 103 only has to use the classification of a type-specific field as “ID1,” rather than the classification of type-specific fields as “ID2.” Specifically, the type estimation means 103 only has to handle information, obtained by combining respective records of information in the fields A and B, as each record of information in the concatenated field. In the case of the example, “Osaka-shi (Osaka city)” as a candidate registered in the first record of the field A and “Kita-ku (Kita ward)” as a candidate registered in the first record of the field B are combined. The type estimation means 103 only has to handle combined “Osaka-shi, Kita-ku” as a candidate registered in the first record of the concatenated field and compare it with each record of the input log.

For example, suppose that input information (for example, six records) depicted in FIG. 11(b) is stored as the input log. FIG. 11(c) depicts the number of matched log records, the matching ratio, and the estimation result of each type-specific field obtained as a result of comparison between the content of each record of the input log and the content of each record of the type-specific field in the classification “ID1” of the type-specific correct answer input DB 102 depicted in FIG. 11(a). Specifically, FIG. 11(b) and FIG. 11(c) depict that the number of matched log records in the “concatenated field AB” is six, the number of matched log records in the “rest” is zero, the matching degrees calculated based on the numbers of matched log records are 1.0 in the “concatenated field AB” and 0 in the “rest,” and the estimation result of the highest matching degree under this condition is the “concatenated field AB.”

Although the example of having only the “concatenated field AB” as the type-specific field in the classification of “ID1” is depicted in FIG. 11(a), any other type-specific field (including a concatenated field) may also be contained. In such a case, the type estimation means 103 only has to calculate a matching degree for any other type-specific field and determine a type-specific field with the highest matching degree to be the estimation result.

Further, when a concatenated field obtained by concatenating type-specific fields having a magnitude relationship in terms of the granularity of information as in the example is determined to be the estimation result, the type estimation means 103 may further output, as priority elements, some of candidates (elements) specially defined from respective records contained in type-specific fields that constitute the concatenated field. The candidates set as the priority elements may be candidates effectively used in the past in the type-specific field from the tendency of the input log, or candidates particularly likely to be used as input information.

For example, when the type-specific field as the type estimation result is a concatenated field, the type estimation means 103 may acquire the contents of records matching the input log in a type-specific field larger in granularity between the type-specific fields that constitute the concatenated field, and output the sum set as a priority element. FIG. 11(d) is an explanatory diagram depicting an example of acquiring a priority element. In the example depicted in FIG. 11(d), “Sakai-shi” as the content of records matching the input log is acquired from the “field A” as a type-specific field containing information larger in granularity between type-specific fields combined in the concatenated field AB, and set as a priority element.

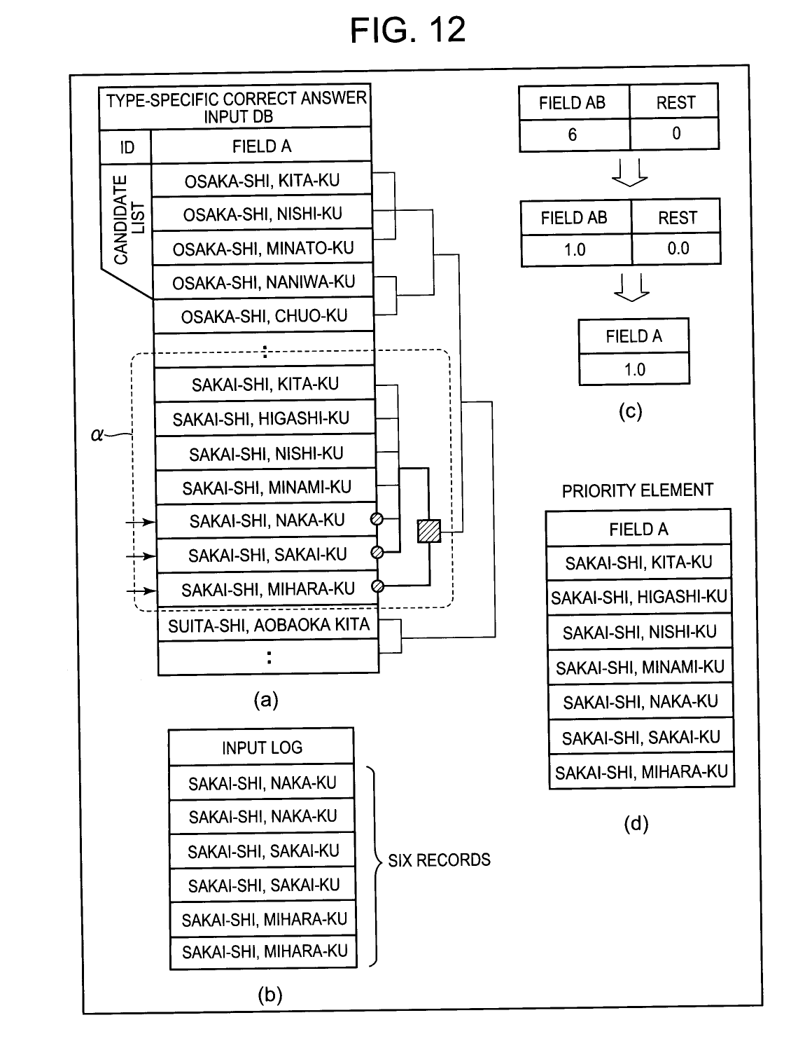

Further, as depicted in FIG. 12, even when a type-specific field as the estimation result is not a concatenated field, the type estimation means 103 may acquire a priority element using the result of clustering performed on respective records in the type-specific field. FIG. 12 is an explanatory diagram depicting an example of acquiring a priority element using clustering based on the degree of similarity between record contents. For example, as depicted in FIG. 12(a), clustering based on the similarity between record contents is performed in each type-specific field as preprocessing. For example, when the content of a record is a character string, clustering may be performed based on the distance between character strings. Specifically, edit distance, information distance vectorized using an n-gram, or the like is used. A weighted distance to change the degree of importance depending on the character position such as to give a weight to matching between first character strings may also be used for clustering.

For example, suppose that input information (for example, six records) depicted in FIG. 12(b) is stored as an input log. FIG. 12(c) depicts the number of matched log records in each type-specific field, the matching ratio, and the estimation obtained as a result of comparison between such a content of each record of the input log and the content of each record contained in each type-specific field of the type-specific correct answer input DB 102 depicted in FIG. 12(a). Specifically, FIG. 12(b) and FIG. 12(c) depict that the number of matched log records in the “field A” is six, the number of matched log records in the “rest” is 0, the matching degrees calculated based on the numbers of matched log records is 1.0 in the “field A” and 0 in the “rest,” and the estimation result of the highest matching degree under this condition is the “field A.”

In such estimation processing, the type estimation means 103 holds a result of identifying to which record in the type-specific field the input log corresponds. Then, when determining a type-specific field to be the estimation result, the type estimation means 103 may acquire a cluster including records matching with the input log in the type-specific field, and set the sum set of elements as priority elements. In FIG. 12(a), a hatched rectangular mark indicates a position as the sum set of the cluster. Further, a range a indicates a record range to be acquired as the priority elements. Further, FIG. 12(d) depicts an example of priority elements acquired in this example.

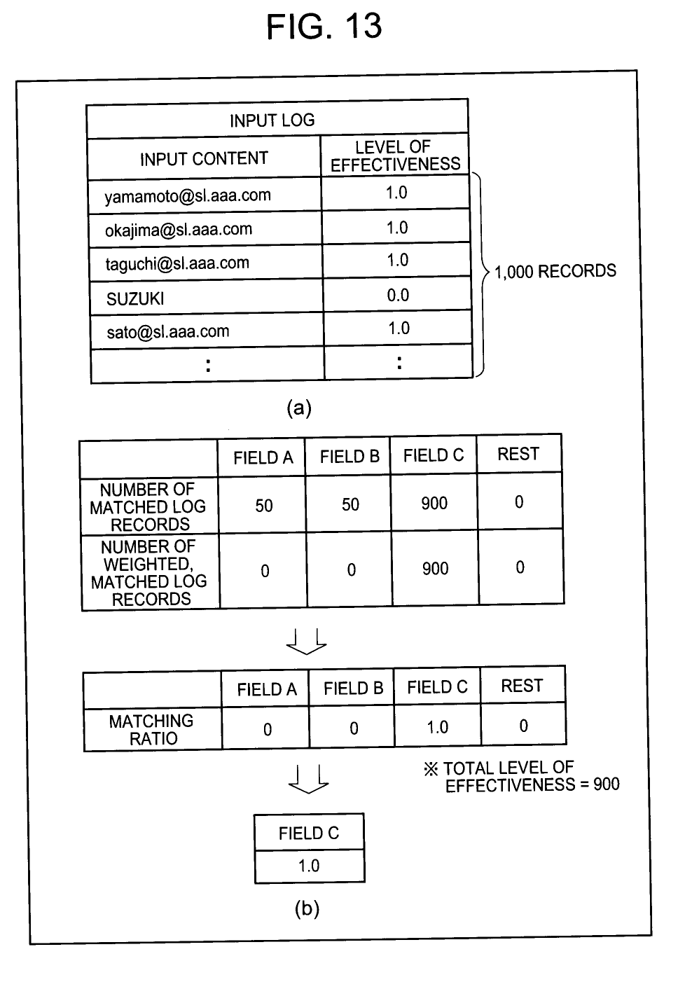

As depicted in FIG. 13, the type estimation means 103 may also perform estimation processing using an input log with levels of effectiveness. FIG. 13(a) is an explanatory diagram depicting an example of the input log with levels of effectiveness. FIG. 13(b) is an explanatory diagram depicting an example of the results of estimation processing using the input log with levels of effectiveness. Note that FIG. 13(a) depicts an example of an input log in which the level of effectiveness is 1 when approved by the input content of a corresponding record or 0 when disapproved. Such a log with levels of effectiveness can be obtained, for example, by waiting for the result of error determination of the input upon registration of the log to register the log together with the result. For example, the type estimation means 103 may handle the level of effectiveness attached to each record of the input log as a weight to quantify the matching degree. For example, the type estimation means 103 may handle this level of effectiveness as a weight to set results with the weight added thereto as the number of matched log records, rather than to add 1 per log record, when calculating the number of matched log records. When the matching ratio is used as the matching degree, the type estimation means 103 only has to divide the value thus obtained (the number of matched log records with the weight, i.e., the total value of the levels of effectiveness) by the sum of levels of effectiveness of respective records contained in the input log.

FIG. 13(b) depicts the number of matched log records in each type-specific field, the number of weighted, matched log records, the matching ratio, and the estimation result obtained as a result of comparison between the content of each record of the input log depicted in FIG. 13(a) and the content of each record in the type-specific correct answer input DB 102 depicted in FIG. 9. FIG. 13(b) depicts an example in which, although the number of matched log records is 50 in both the “field A” and the “field B,” the number of weighted, matched log records is 0 because the level of effectiveness attached to corresponding log records is 0 in both fields.

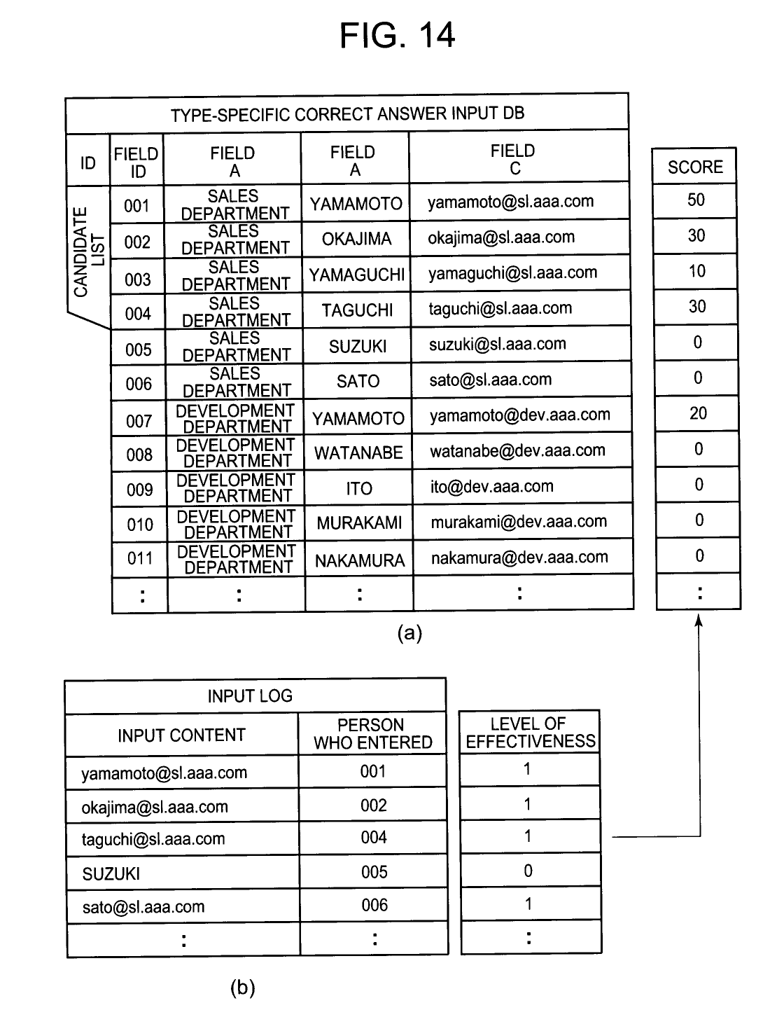

Further, as depicted in FIG. 14, as a result of the type-of-input information estimation processing, the type estimation means 103 may calculate a score, using a log with information indicative of a person who entered data, for each record in a type-specific field identified to correspond to the type of input box to be estimated. Then, the type estimation means 103 may hold the calculated score in the type-specific correct answer input DB 102, or output it together with the estimation result. Here, the score of each record is not particularly limited as long as the score is a value based on the matching degree with the input log of a user specified.

FIG. 14(a) is an explanatory diagram depicting an example when the score is calculated in estimation processing with a score attached to each record in the type-specific correct answer input DB 102. FIG. 14(b) is an explanatory diagram depicting an example of an input log with information on persons who entered data, and the levels of effectiveness associated with the input log. Such an input log with information indicative of persons who entered data can be obtained, for example, by using an authentication system, in which an ID or the like for identifying a user as a person who entered data in an input box is entered upon system login, to register the ID entered upon login together with the log when the log is registered. In the estimation processing, for example, the type estimation means 103 holds a result of identifying to which record of a type-specific field the input log corresponds. When determining a type-specific field as an estimation result, the type estimation means 103 may calculate a score for each user (e.g., a user currently logged in) specified in the type-specific field. For example, the type estimation means 103 may calculate a score by adding 1 to a record that matches the input log with the ID of the specified user, or calculate a score by adding a level of effectiveness when the level of effectiveness is attached to the log. In such a case, when there are many records entered by the specified user with correct contents in the past, the type estimation means 103 may adjust the score to make the calculated score larger.

If such a score of each record corresponding to each individual user is provided together with the estimation result, finer input support is possible such as to be able to recommend a candidate suitable for the user when subsequent processing means suggests an input candidate.

As described above, according to the exemplary embodiment, there is no need to specify the type of data that can be input in detail in advance as to what is input to the input box including the granularity of information. The input support system of the exemplary embodiment can identify information indicative of correct input, such as an information group or an input format that matches the type of information to be input to an input box, based on a log of information input to the target input box in the past and information in the type-specific correct answer input DB 102, and provide the information as the estimation result. Then, this estimation result can be used to provide input support for various input boxes, such as to make an error determination or perform predictive conversion. Further, according to the exemplary embodiment, the type-specific correct answer input DB 102 and a log when correct input was done can be combined to dynamically derive the type of any information as an estimation result without giving detailed specifications to the input box in advance. Therefore, a fine input support system can be easily introduced.

For example, according to the exemplary embodiment, the classification of types to be registered in the type-specific correct answer input DB 102 can be controlled to make a fine determination of granularity as to which is easier to enter, an address in Tokyo or a commonly used address, even when both are the same address. This determination can increase the accuracy of predictive conversion or an error determination. Further, according to the exemplary embodiment, the type or granularity of information to be input to an input box can be changed depending on the setting of the input log even when the system is in operation.

### Exemplary Embodiment 2

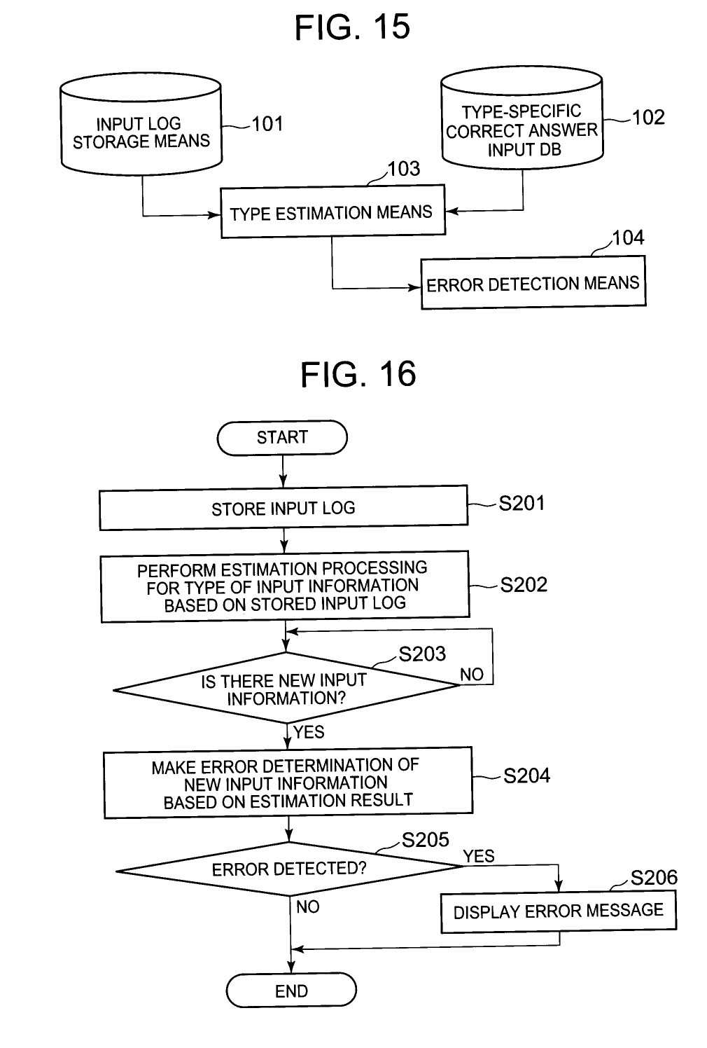

Next, a second exemplary embodiment of the present invention will be described. FIG. 15 is a block diagram depicting a configuration example of an input support system of the second exemplary embodiment. The input support system depicted in FIG. 15 is different from the first exemplary embodiment depicted in FIG. 1 in that error detection means 104 is newly provided.

The error detection means 104 makes an error determination of information newly input to a target input box based on the estimation result and other information (e.g., information on priority elements, a record-specific score, and the like) output from the type estimation means 103 to detect an error. When an error is detected as a result of the error determination, the error detection means 104 outputs a message indicating that effect.

For example, the error detection means 104 determines whether information newly input to the target input box matches information indicative of correct input contained in a type-specific field obtained as an estimation result, and if they do not match, the error detection means 104 may determine it to be an error. The matching determination here may be basically the same as the matching determination made when the number of matched log records is calculated in the type estimation means 103. In other words, when an input format is registered in the type-specific correct answer input DB 102 as information indicative of correct input, the error detection means 104 may determine an error by determining whether information newly input to the target input box matches the input format. Further, for example, when a list of candidates for input information is registered as information indicative of correct input, the error detection means 104 uses, as a search field, a type-specific field obtained as an estimation result to search the type-specific field for a candidate(s) that matches the information newly input to the target input box. Then, when there is no matched candidate, the error detection means 104 may determine an error. Further, for example, it is assumed that an example of input information is registered as information indicative of correct input. In this case, the error detection means 104 may determine an error by determining whether both formats match, or may handle each piece of information as character string information to determine an error by determining whether similarity between both character strings is a predetermined value or more.

In the exemplary embodiment, for example, the error detection means 104 is implemented by an information processing apparatus operating according to a CPU program or the like.

FIG. 16 is a flowchart depicting an example of operation of the input support system of the exemplary embodiment. Suppose first that information input to the target input box in the past is stored as an input log in the input log storage means 101 (step S201). Then, the type estimation means 103 estimates the type of input information in the input box based on the input log of the input box stored in the input log storage means 101 and information stored in the type-specific correct answer input DB 102, more specifically, information indicative of type-specific correct input (step S202). Here, the type estimation means 103 obtains, as an estimation result, at least information indicative of a type-specific field corresponding to the type of input information in the input box.

Here, when new information is input to the target input box (Yes in step S203), the error detection means 104 makes an error determination of the input information (step S204). When an error is detected (Yes in step S205), an error message is displayed (step S206).

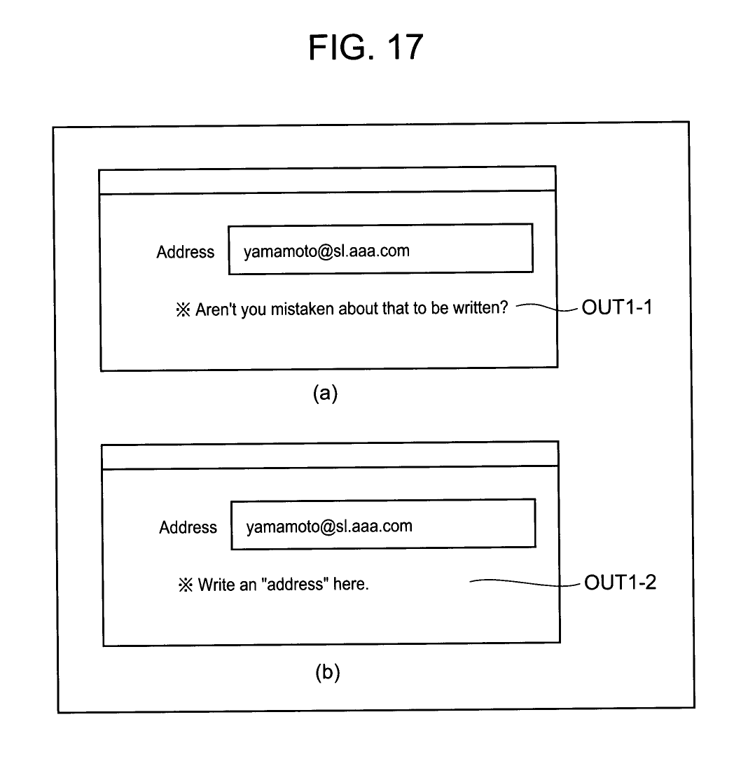

FIG. 17 is an explanatory diagram depicting display examples of error messages. For example, suppose that the error detection means 104 accepts input of “yamamoto@sl.aaa.com” as new input information to a target input box. In this example, it is assumed that information indicative of the “field A” of the type-specific correct answer input DB 102 depicted in FIG. 3 is obtained as the estimation result of the type of information to be input to the input box. Note that the type-specific correct answer input DB 102 depicted in FIG. 3 has one type-specific field as the “field A,” and an information group (a list of candidates) indicative of “addresses” is registered in the “field A.”

In such a case, the error detection means 104 sets, as a search field, the type-specific field determined to be the estimation result, and if information that matches the input information is found from the list of candidates in the search field, the error detection means 104 may determine that there is no error. On the other hand, if information that matches the input information is not found, the error detection means 104 may treat the information as a potential input error and give notice of that effect. For example, the error detection means 104 may output a message (OUT1-1) saying “Aren't you mistaken about that to be written?” as depicted in FIG. 17(a). Further, when a title (e.g., “Address”) is given to the type-specific field determined to be the estimation result, the error detection means 104 may use the title to output a message (OUT1-2) saying “Write an ‘address’ here” using the title as depicted in FIG. 17(b). In still another case, for example, when the description of the type of information is registered in the type-specific correct answer input DB 102, the error detection means 104 may use the description to output a message such as to say “Write an ‘(address beginning with the name of a prefecture, for example)’ here.”

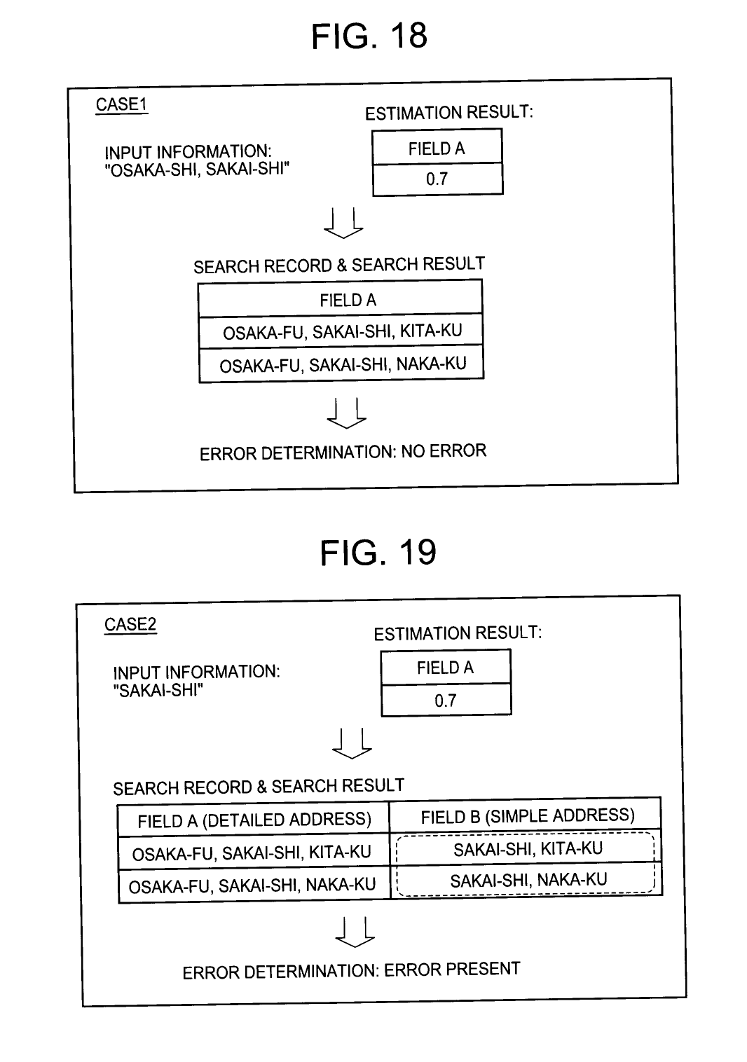

Further, when the type-specific correct answer input DB 102 has type-specific fields corresponding to multiple description formats, the error detection means 104 may add any other type-specific field to the search field, rather than setting, as a search field, only the type-specific field determined to be the estimation result. Note that as a result of searching the type-specific field once determined to be the estimation result, if no match is found, it will be possible to add any other type-specific field to the search field to make a search again. FIG. 18 to FIG. 21 are explanatory diagrams depicting examples of error determinations and examples of error messages when the type-specific correct answer input DB 102 has type-specific fields corresponding to multiple description formats.

In this example, suppose that the error detection means 104 has obtained information indicative of the “field A” of the type-specific correct answer input DB 102 depicted in FIG. 6 as the estimation result of the type of information to be input to a target input box. It is assumed that the type-specific correct answer input DB 102 depicted in FIG. 6 has two type-specific fields of “field A” and “field B,” and information groups (lists of candidates) representing “addresses” are registered in both the “field A” and the “field B.” Further, it is assumed that information indicative of such a relationship between the type-specific fields that the “field A” takes a more detailed description format is held in the type-specific correct answer input DB 102 in advance.

Suppose here that input of “Osaka-fu, Sakai-shi” is accepted as new input information to the target input box. The example depicted as CASE1 in FIG. 18 is an example of an error determination result when two candidates are found as a result of first setting, as a search field, the “field A” as a type-specific field determined to be the estimation result to find a match (e.g., a forward match) with the input information from among respective candidates in the search field. The error determination result in this case is “No error.”

On the other hand, suppose that input of “Sakai-shi” is accepted as new input information to the target input box at different timing. The example depicted as CASE2 in FIG. 19 assumes that no match with the input information is found only by setting, as the search field, the “field A” as the type-specific field determined to be the estimation result. In addition, the example depicted as CASE2 in FIG. 19 is an example of an error determination result when data matching a type-specific field different from the type-specific field determined to be the estimation result is found as a result of adding, to the search field, the “field B” as a type-specific field having the same entries to make a further search. The error determination result in this case is “Error present.”

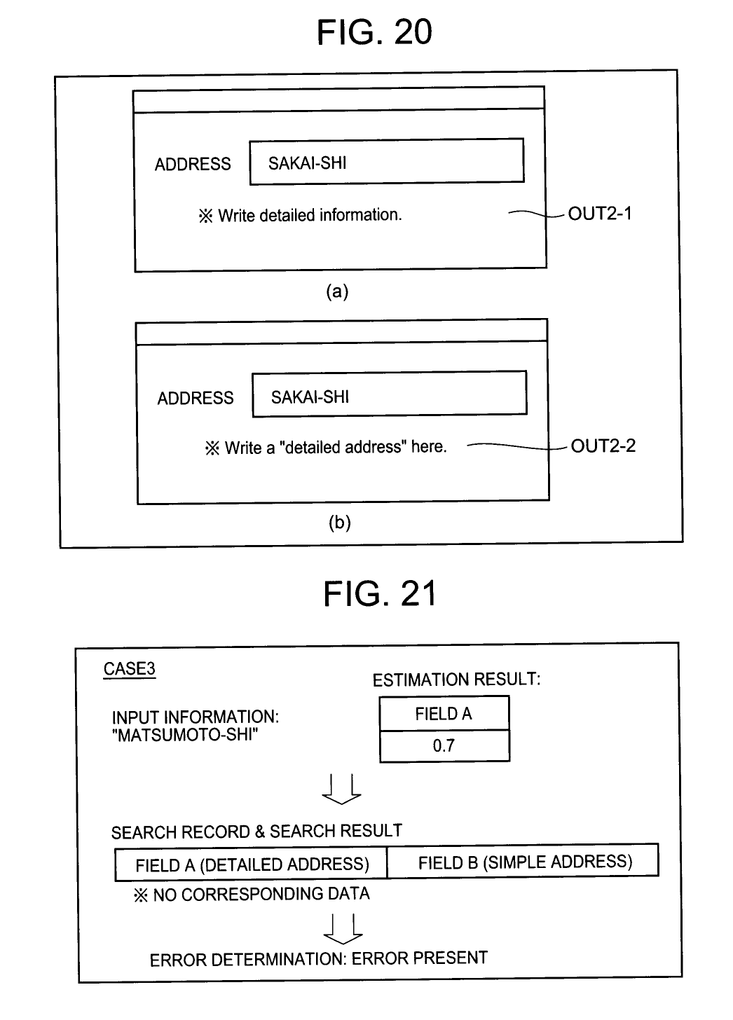

In such a case, the error detection means 104 may display the following error messages as well as error messages as depicted in FIG. 17. Namely, if a relationship between the type-specific field determined to be the estimation result and a type-specific field with which the input information matches (for example, which of them is more detailed) is found, the error detection means 104 may create an error message based on such a relationship. For example, as depicted in FIG. 20(a), suppose that the input information matches a type-specific field less detailed than and different from the type-specific field determined to be the estimation result. In this case, the error detection means 104 may output a message (OUT2-1) saying “Write detailed information.” When a field name is given to the type-specific field, the error detection means 104 may further use the field name to output a message (OUT2-2) saying “Write a ‘detailed address’ here.”

Suppose further that the input information matches a type-specific field more detailed than and different from the type-specific field determined to be the estimation result. In this case, the error detection means 104 may compare the contents of both records, detect a difference, and use the detected difference to output a message saying “No ‘00’ (Osaka-fu (Osaka prefecture) in this example) is necessary here.”

The example depicted as CASE3 in FIG. 21 is an example of an error determination result when no match is found even if the “field B” as a type-specific field having the same entries is added to the search field. The error determination in this case is “Error present.” In such a case, the error detection means 104 may output an error message as depicted in FIG. 17.

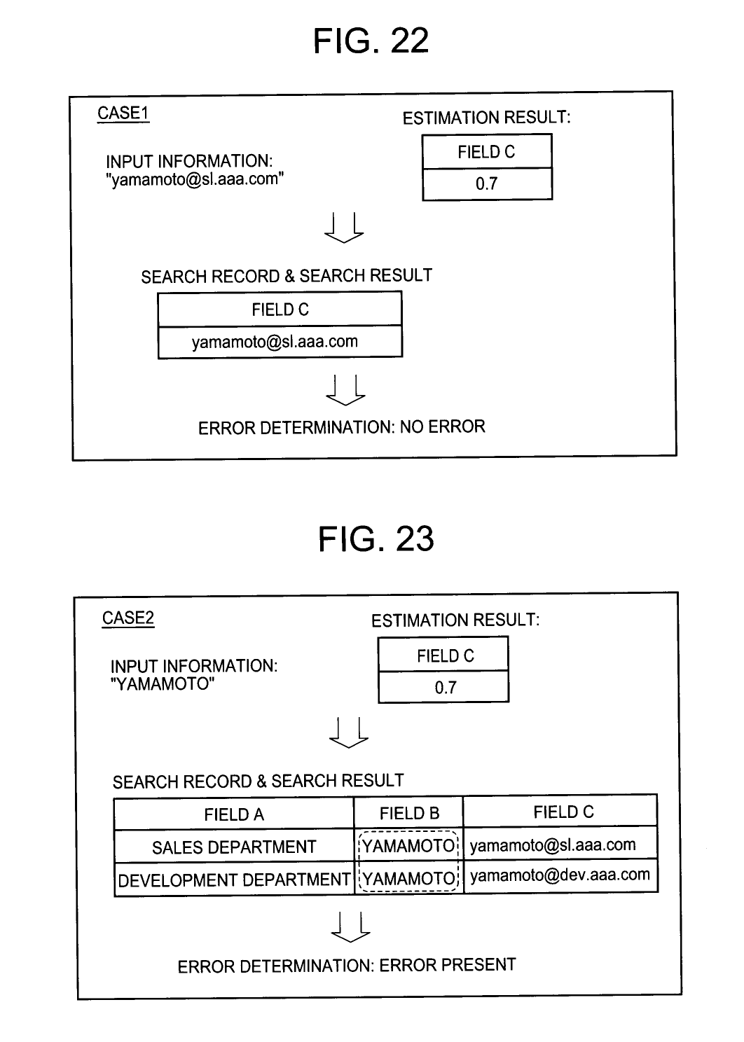

Further, when the type-specific correct answer input DB 102 has multiple type-specific fields, the error detection means 104 may set all the type-specific fields as search fields regardless of the presence or absence of entry identity among them. Even in this case, if there is no match as a result of searching a type-specific field once determined to be the estimation result, it will also be possible to add the other type-specific fields to the search field to make a search again. FIG. 22 to FIG. 25 are explanatory diagrams depicting examples of error determinations and examples of error messages when the type-specific correct answer input DB 102 has multiple type-specific fields including those having no entry identity.

In this example, suppose that the error detection means 104 has obtained information indicative of the “field C” of the type-specific correct answer input DB 102 depicted in FIG. 9 as the estimation result of the type of information to be input to a target input box. Note that the type-specific correct answer input DB 102 depicted in FIG. 9 has the “field A” and the “field B” as well as the “field C,” and these type-specific fields have different entries but the respective records thereof are associated with one another.

Suppose here that input of “yamamoto@sl.aaa.com” is accepted as new input information to the target input box. The example depicted as CASE1 in FIG. 22 is an example of an error determination result when one candidate is found as a result of first setting, as a search field, the “field C” as a type-specific field determined to be the estimation result to find a match (e.g., a forward match) with the input information from respective candidates in the search field. The error determination result in this case is “No error.”

On the other hand, suppose that input of “Yamamoto” is accepted as new input information to the target input box at different timing. The example depicted as CASE2 in FIG. 23 assumes that no match with the input information is found only by setting, as the search field, the “field C” as the type-specific field determined to be the estimation result. In addition, the example depicted as CASE2 in FIG. 23 is an example of an error determination result when data matching the “field B” as a type-specific field different from the type-specific field determined to be the estimation result is found as a result of adding the remaining type-specific fields of “field A” and “field B” to make a further search. The error determination result in this case is “Error present.”

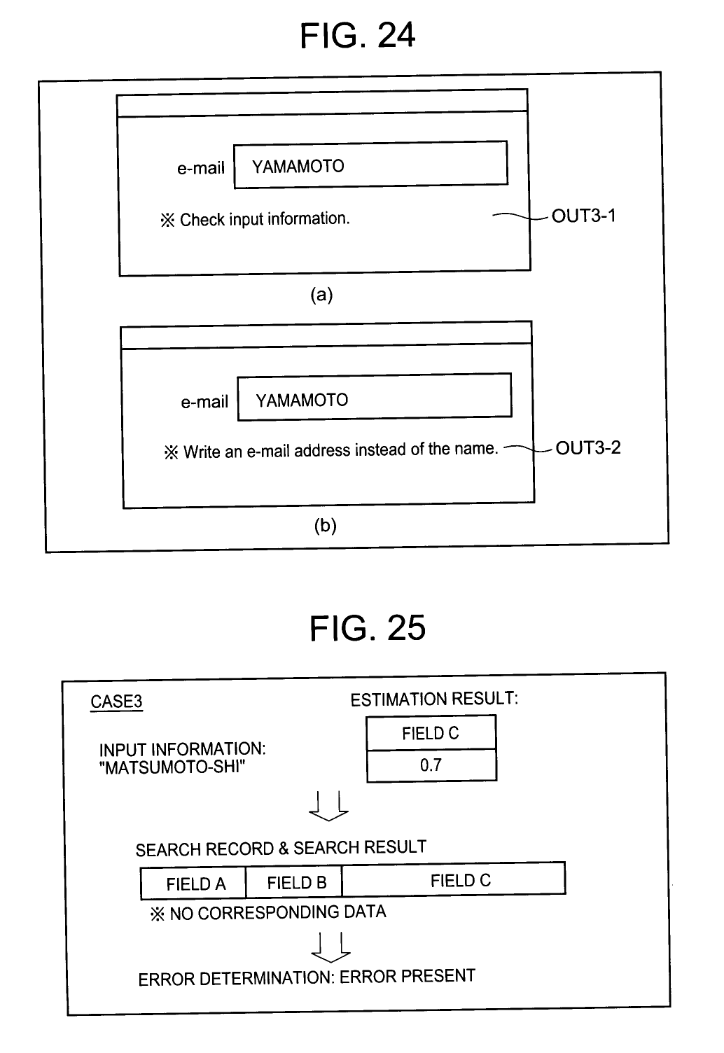

In such a case, the error detection means 104 may display the following error messages as well as error messages as depicted in FIG. 17. Namely, for example, the error detection means 104 may output a message (OUT3-1) saying “Check input information,” which can imply that the type of input information is different as depicted in FIG. 24(a). Further, for example, when a field name is given to the type-specific field, the error detection means 104 may further use the field name to output a message (OUT3-2) saying “Write an ‘e-mail address’ instead of the ‘name’.” The example depicted with the message (OUT3-2) is an example when the title of the “field B” as the type-specific field from which a match is found is “Name,” and the title of the “field C” as the type-specific field determined to be the estimation result is “E-mail address.”

The example depicted as CASE3 in FIG. 25 is an example of an error determination result when no match is found even if the remaining type-specific fields are added to the search field. The error determination in this case is “No error.” In such a case, the error detection means 104 may output an error message as depicted in FIG. 17.

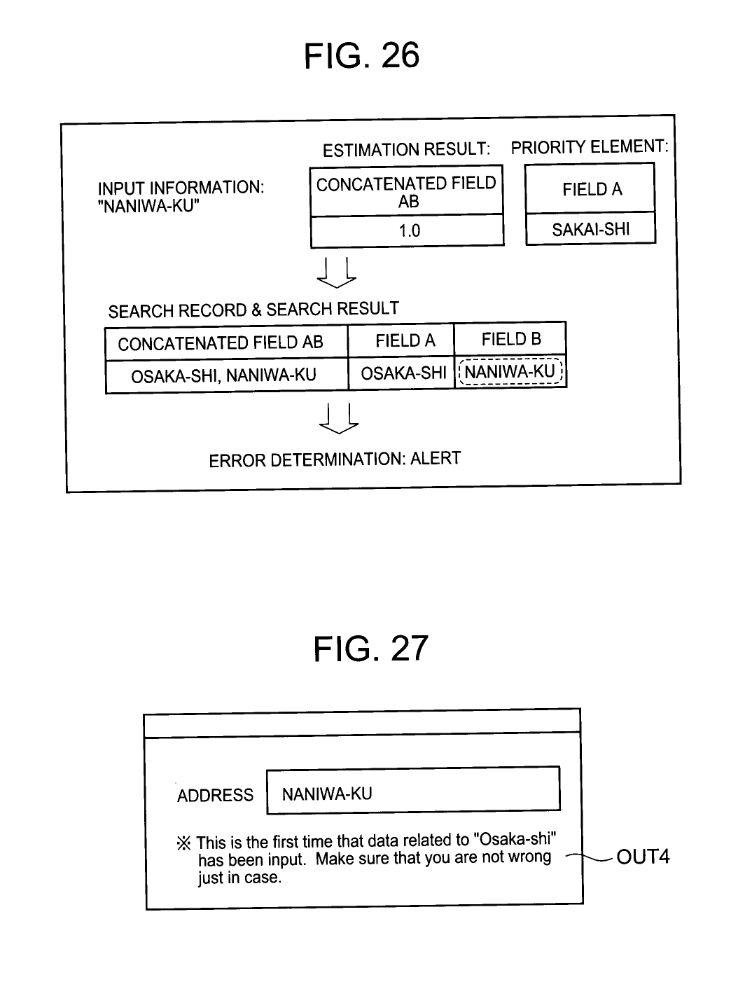

Further, when a priority element is given in addition to the estimation result, the error detection means 104 may use them to make an error determination. FIG. 26 and FIG. 27 are explanatory diagrams depicting an error determination when a priority element is given in addition to the estimation result. For example, suppose that the error detection means 104 has obtained information indicative of the “concatenated field AB” of the type-specific correct answer input DB 102 depicted in FIG. 11(a) as the estimation result of the type of information to be input to a target input box. Suppose further that the error detection means 104 has obtained information on a priority element depicted in FIG. 11(d) together. Note that the “concatenated field AB” of the type-specific correct answer input DB 102 depicted in FIG. 11(a) is obtained by concatenating the “field A” and the “field B,” and information groups representing “addresses” are registered in the two fields, respectively. Further, it is assumed that information indicative of such a relationship between type-specific fields that the “field A” is larger in granularity of information is held in the type-specific correct answer input DB 102 in advance. The information on the priority element depicted in FIG. 11(d) is information indicating that the priority element field is set to the “field A” and “Sakai-shi” is set as the priority element in the priority element field.

Suppose here that input of “Naniwa-ku” is accepted as new input information to a target input box. In the example depicted in FIG. 26, it is first determined whether this input information is included in each candidate inside the “concatenated field AB” as the type-specific field determined to be the estimation result. Further, in the example depicted in FIG. 26, it is determined, in addition to this determination, whether there is a match (e.g., a forward match) with this input information from among respective candidates of the “field A” and “field B” concatenated as the “concatenated field AB.” As a result, FIG. 26 depicts that a match with the “field B” is retrieved. In the case of the example, the content of the priority element field contained in the matched record is “Osaka-shi,” which is not the priority element. Therefore, in the example depicted in FIG. 26, the error detection means 104 displays a determination result to alert a user to a potential input error.

Thus, even when input information matches a type-specific field to be estimated, the content may not be a priority element or may not include a priority element. In this case, the error detection means 104 may output a message to make the user confirm that the content has been input for the first time as depicted in FIG. 27. FIG. 27 depicts an example of outputting an error message (OUT4) saying “This is the first time that data related to “Osaka-shi” has been input. Make sure that you are not wrong just in case.”

Thus, the use of a priority element enables an error determination based on the past input trend.

Further, when a score is given to each record of the type-specific field determined to be the estimation result together with the estimation result, the error detection means 104 may make an error determination using the score. For example, when input information matches a candidate having a score smaller than a predetermined value, the error detection means 104 may output a similar confirmation message such as to notify the user that the information was seldom input in the past Even when no record-specific score is calculated in the type-of-input information estimation processing, the error detection means 104 may count how many input log records that match the content of an acquired record are contained to calculate a score. Then, the error detection means 104 may make an error determination using the calculated score.

As described above, according to the exemplary embodiment, since the error detection means 104 can make an error determination using an estimation result by the type estimation means 103 without specifying, in advance, the type of data that can be input, accurate input information can be obtained.

### Exemplary Embodiment 3

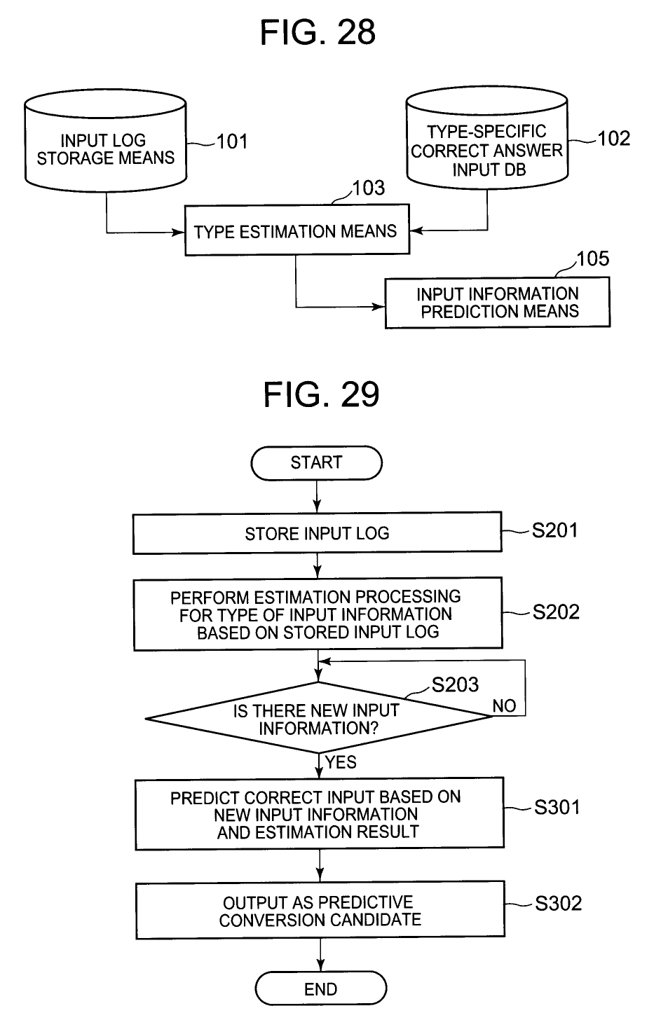

Next, a third exemplary embodiment of the present invention will be described. FIG. 28 is a block diagram depicting a configuration example of an input support system of the third exemplary embodiment. The input support system depicted in FIG. 28 is different from the first exemplary embodiment depicted in FIG. 1 in that input information prediction means 105 is newly provided.

The input information prediction means 105 predicts information to be input to a target input box from information newly input to the input box based on an estimation result and other information (e.g., priority element information, a record-specific score, and the like) output from the type estimation means 103, and presents the information to a user.

In the exemplary embodiment, for example, the input information prediction means 105 is implemented by an information processing apparatus operating according to a CPU program or the like.

FIG. 29 is a flowchart depicting an example of operation of the input support system of the exemplary embodiment. Since steps S201 to S203 in FIG. 29 are the same as in the second exemplary embodiment depicted in FIG. 16, the description thereof will be omitted below.

In the exemplary embodiment, when new input to the target input box is done (Yes in step S203), the input information prediction means 105 predicts correct input information to be input to the input box based on the input information and at least information indicative of a type-specific field determined to be the estimation result (step S301). Then, the input information prediction means 105 outputs the result as a predictive conversion candidate (step S302).

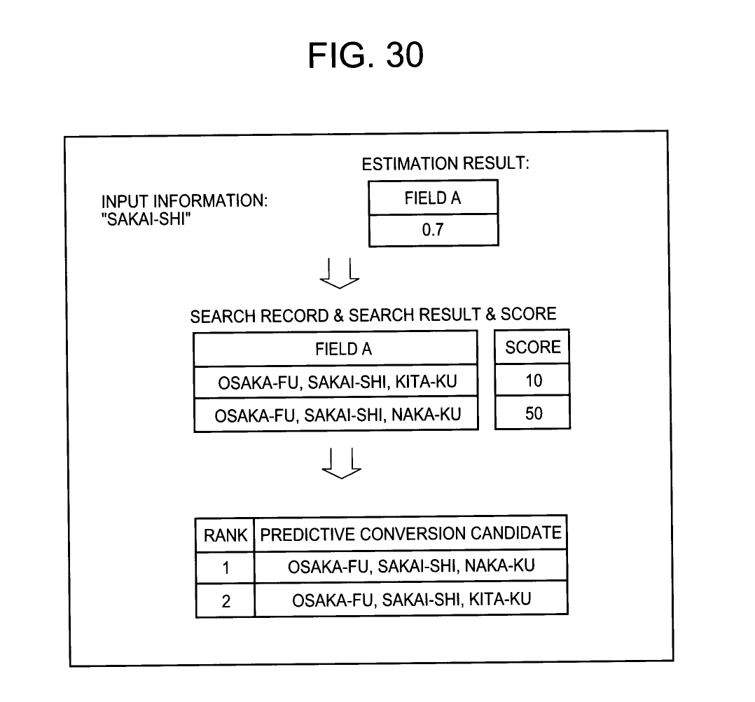

FIG. 30 is an explanatory diagram depicting prediction processing by the input information prediction means 105. In this example, it is assumed that the input information prediction means 105 has obtained information indicative of the “field A” of the type-specific correct answer input DB 102 depicted in FIG. 3 as the estimation result of the type of information to be input to the target input box. Note that the type-specific correct answer input DB 102 depicted in FIG. 3 has one type-specific field as the “field A,” and an information group (a list of candidates) representing “addresses” is registered in the “field A.”

Suppose here that input of “Sakai-shi” is accepted as new input information to the target input box. In such a case, the input information prediction means 105 may set, as a search field, the “field A” as a type-specific field determined to be the estimation result, and acquire records including the input information from the list of candidates in the search field to set them as predictive conversion candidates. In the example depicted in FIG. 30, two records of “Osaka-fu, Sakai-shi, Kita-ku” and “Osaka-fu, Sakai-shi, Naka-ku” are acquired. Further, the input information prediction means 105 may acquire a score of each acquired record based on the input log, and rank a predictive conversion candidate based on the acquired score to present each acquired record. When no record-specific score is calculated in the type-of-input information estimation processing, the input information prediction means 105 may count how many input log records that match the content of an acquired record are contained to set it as the score. In the example depicted in FIG. 30, “Osaka-fu, Sakai-shi, Naka-ku” having the highest score as the first predictive conversion candidate and “Osaka-fu, Sakai-shi, Kita-ku” having the second highest score as the second predictive conversion candidate are present.

Thus, with only input of “Sakai-shi,” information including it and meeting the description format as information to be input to the input box is presented as a predictive conversion candidate. This not only allows the user to enter information in a right description format, but also can save the effort of the user to enter the information. Further, in the example, the input log is used consistently to estimate the type of input information and rank candidates, rather than to generate predictive conversion candidates from the input log. Since the contents of candidates are acquired using information in the type-specific correct answer input DB 102, correct input information can be predicted to present conversion candidates even when there was no input of “Sakai-shi” in the past.

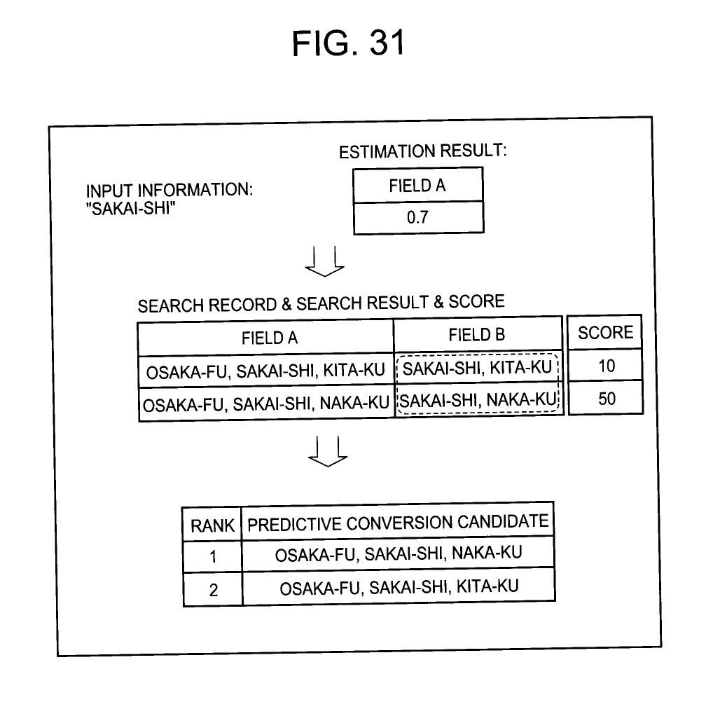

FIG. 31 is an explanatory diagram depicting another example of prediction processing by the input information prediction means 105. In the example, it is assumed that the input information prediction means 105 has obtained information indicative of the “field A” of the type-specific correct answer input DB 102 depicted in FIG. 6 as the estimation result of the type of information to be input to the target input box. Note that the type-specific correct answer input DB 102 depicted in FIG. 6 has two type-specific fields of “field A” and “field B,” and information groups representing “addresses” are registered in both the “field A” and the “field B.” It is also assumed that information indicative of such a relationship between type-specific fields that the “field A” takes a more detailed description format is held in the type-specific correct answer input DB 102 in advance. Further, in the example, it is assumed that at least respective records in these type-specific fields are associated with each other.

Suppose here that input of “Sakai-shi” is accepted as new input information to the target input box. In such a case, the input information prediction means 105 may first set, as search fields, the “field A” as a type-specific field determined to be the estimation result and the “field B” having the same entries as the “field A” to make a search for a match (forward match) with the input information from respective candidates in the search fields. Then, if there is any corresponding one, the input information prediction means 105 may acquire, as a predictive conversion candidate, the content of a record in the record position of the type-specific field determined to be the estimation result.

In the example depicted in FIG. 31, since two records “Sakai-shi, Kita-ku” and “Sakai-shi, Naka-ku” correspond in the “field B,” “Osaka-fu, Sakai-shi, Kita-ku” and “Osaka-fu, Sakai-shi, Naka-ku” as the contents of records in the “field A” corresponding to these two records are acquired as predictive conversion candidates.

Then, the input information prediction means 105 acquires scores of the acquired records based on the input log, and ranks and presents the predictive conversion candidates based on the obtained scores. When no record-specific scores are calculated in the type-of-input information estimation processing, the input information prediction means 105 may calculate the scores. In the example depicted in FIG. 31, “Osaka-fu, Sakai-shi, Naka-ku” having the highest score as the first predictive conversion candidate and “Osaka-fu, Sakai-shi, Kita-ku” having the second highest score as the second predictive conversion candidate are present.

Thus, when the type of information to be input to the target input box is identified, input information can then be converted to such a type of information. In the case of the example, only input of “Sakai-shi” leads to presenting candidates including input characters and meeting the description format of the input box. This not only allows the user to enter information in a right description format, but also can save the effort of the user to enter the information. Further, in the exemplary embodiment, such a predictive conversion function can be carried out even in a state where there is no input log of “Sakai-shi.” Further, like in the example, if information stored in the type-specific correct answer input DB 102 is used as conversion knowledge, the user can get predictive conversion candidates without being aware of what the type is. The input format, the description of the type, or the like registered in the type-specific correct answer input DB 102 may be used instead of using the information stored in the type-specific correct answer input DB 102 as conversion knowledge. In this case, the input information prediction means 105 may use a conversion process in another system based on this input format, description of the type, or the like to convert input information to information that meets the description format and present the information as a predictive conversion candidate.

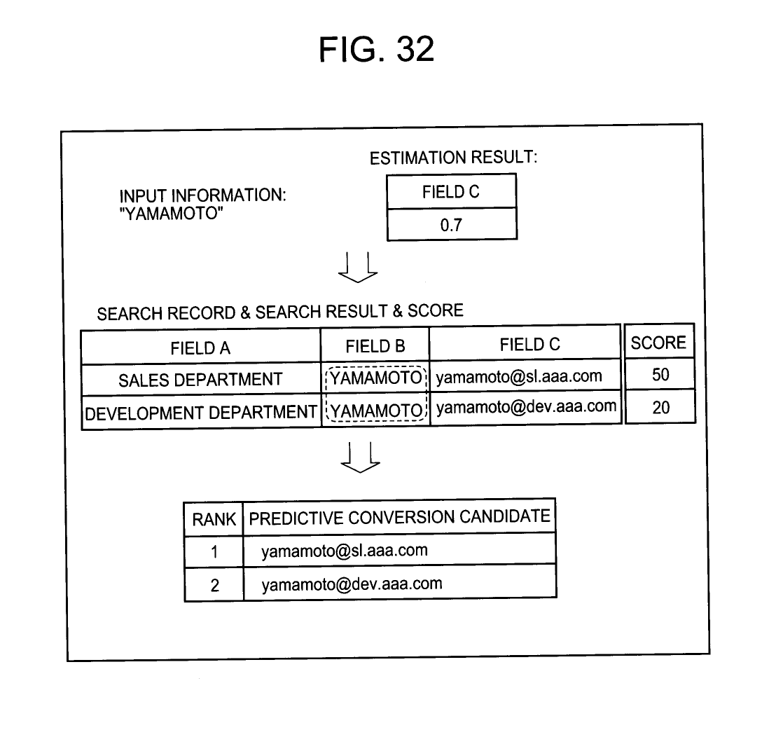

FIG. 32 is an explanatory diagram depicting still another example of prediction processing by the input information prediction means 105. In this example, it is assumed that the input information prediction means 105 has obtained information indicative of the “field C” of the type-specific correct answer input DB 102 depicted in FIG. 9 as the estimation result of the type of information to be input to the target input box. Note that the type-specific correct answer input DB 102 depicted in FIG. 9 has the “field A” and the “field B” as well as the “field C,” and these type-specific fields have different entries but the respective records thereof are associated with one another.

Suppose here that input of “Yamamoto” is accepted as new input information to the target input box. In such a case, the input information prediction means 105 may set all the type-specific fields as search fields to make a search for those including the input information from respective candidates in these search fields. Then, if there is any corresponding one, the input information prediction means 105 may acquire, as a predictive conversion candidate, the content of a record in the record position of the type-specific field determined to be the estimation result.

In the example depicted in FIG. 32, since two records correspond in the “field B,” “yamamoto@sl.aaa.com” and “yamamoto@dev.aaa.com” as the contents of records in the “field C” corresponding to these two records are acquired as predictive conversion candidates.

Then, the input information prediction means 105 acquires scores of the acquired records based on the input log, and ranks and presents the predictive conversion candidates based on the obtained scores. When no record-specific scores are calculated in the type-of-input information estimation processing, the input information prediction means 105 may calculate the scores. In the example depicted in FIG. 32, “yamamoto@sl.aaa.com” having the highest score as the first predictive conversion candidate and “yamamoto@dev.aaa.com” having the second highest score as the second predictive conversion candidate are present.

Thus, even in the example, only input of “Yamamoto” leads to presenting, as conversion candidates, information related thereto and in a format that meets the type of information to be input to the input box. Therefore, even when the user entered information of a wrong type, the wrong input can be corrected, and the effort of the user can be saved. Further, even if the user does not know the content in a right description format, the user can enter right information. For example, even without specifying that a certain input box is a box to which an address is to be input or the like, conversion to the address from a zip code is possible.

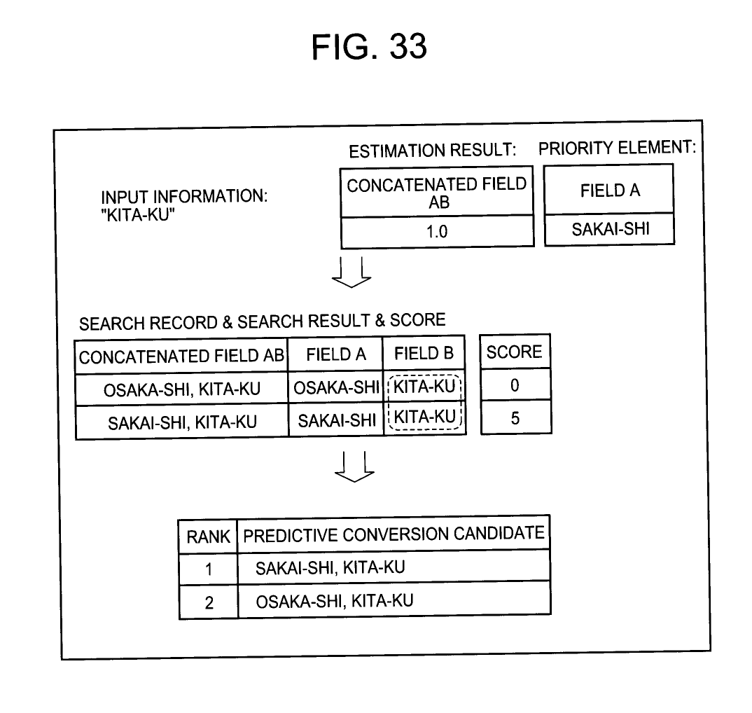

FIG. 33 is an explanatory diagram depicting still another example of prediction processing by the input information prediction means 105. In this example, it is assumed that information indicative of the “concatenated field AB” of the type-specific correct answer input DB 102 depicted in FIG. 11(a) has been obtained as the estimation result of the type of information to be input to the target input box. It is also assumed that information on the priority element depicted in FIG. 11(d) has been obtained together. Note that the “concatenated field AB” of the type-specific correct answer input DB 102 depicted in FIG. 11(a) is obtained by concatenating the “field A” and the “field B,” and information groups representing “addresses” are registered in the two fields, respectively. Further, it is assumed that information indicative of such a relationship between type-specific fields that the “field A” is larger in granularity of information is held in the type-specific correct answer input DB 102 in advance. The information on the priority element depicted in FIG. 11(d) is information indicating that the priority element field is set to the “field A” and “Sakai-shi” is set as the priority element in the priority element field.

Suppose here that input of “Kita-ku” is accepted as new input information to the target input box. In such a case, the input information prediction means 105 may first set, as a search field(s), the “concatenated field AB” as the type-specific field determined to be the estimation result, or the “field A” and the “field B,” to make a search for those including the input information from respective candidates in the search field(s). Then, if there is any corresponding one, the input information prediction means 105 may acquire, as a predictive conversion candidate, the content of a record in the record position of the type-specific field determined to be the estimation result.

In the example depicted in FIG. 33, since two records correspond in the “field B,” “Osaka-shi, Kita-ku” and “Sakai-shi, Kita-ku” as the contents of records in the “concatenated field AB” corresponding to the two records are acquired as predictive conversion candidates.

Then, the input information prediction means 105 acquires scores of the acquired records based on the input log, and ranks and presents the predictive conversion candidates based on the obtained scores. When no record-specific scores are calculated in the type-of-input information estimation processing, the input information prediction means 105 may calculate the scores. In such a case, scores are given, where priority is given to a record included in the input log more times than the other searched records and whose content in the priority element field is the priority element. Thus, the input information prediction means 105 may rank and output predictive conversion candidates based on the obtained scores. In the example depicted in FIG. 33, “Sakai-shi, Kita-ku” having the highest score as the first predictive conversion candidate and “Osaka-shi, Kita-ku” having the second highest score as the second predictive conversion candidate are present.

Thus, even in the example, only input of “Kita-ku” leads to presenting, as conversion candidates, information including it and in a format that meets the type of information to be input to the input box. This allows the user to enter right information easily. Further, in the example, candidates are ranked and presented based on scores in consideration of the priority element. Therefore, for example, although there is no input log record related to “Kita-ku” in the input log depicted in FIG. 11(b), it can be determined from the content of any other log that the likelihood of information including “Sakai-shi” is higher, and hence the candidates thus ranked can be presented.

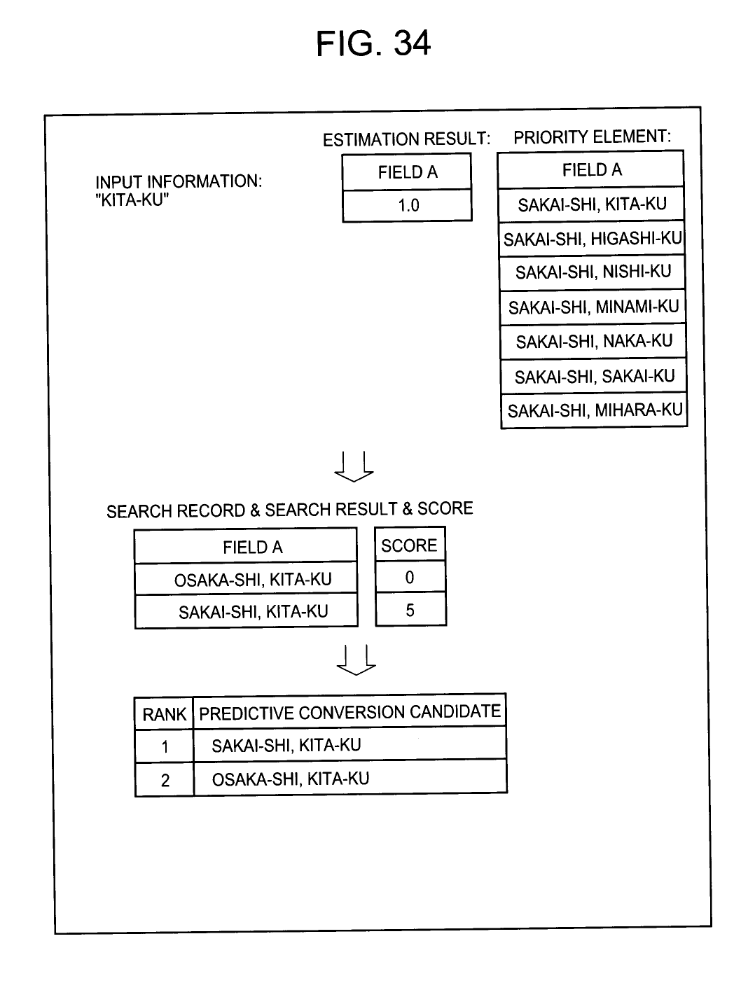

FIG. 34 is an explanatory diagram depicting yet another example of prediction processing by the input information prediction means 105. For example, as depicted in FIG. 34, even when the type-specific field determined to be the estimation result is not a concatenated field, if a priority element is acquired by clustering or the like, the input information prediction means 105 may rank the predictive conversion candidates using the priority element in the same manner. Note that FIG. 34 depicts an example of prediction processing when information on the priority elements depicted in FIG. 12(d) has been obtained together with information indicative of the “field A” of the type-specific correct answer input DB 102 depicted in FIG. 12(a) as the estimation result of the type of information to be input to the target input box.

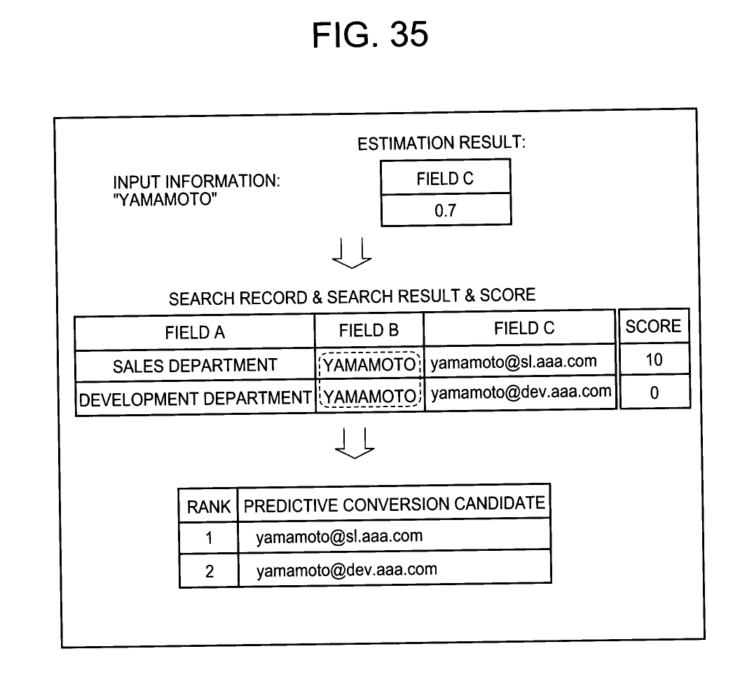

FIG. 35 is an explanatory diagram depicting yet another example of prediction processing by the input information prediction means 105. For example, it is assumed that the input information prediction means 105 has obtained the “field C” of the type-specific correct answer input DB 102 depicted in FIG. 9 as the estimation result of the type of information to be input to the target input box. Note that the type-specific correct answer input DB 102 depicted in FIG. 9 has the “field A” and the “field B” as well as the “field C,” and these type-specific fields have different entries but the respective records thereof are associated with one another. In the example, it is also assumed that the information depicted in FIG. 13(a) is registered as the input log. In other words, it is assumed that an input log with levels of effectiveness is registered.

Suppose here that input of “Yamamoto” is accepted as new input information to the target input box. In such a case, the input information prediction means 105 may set all the type-specific fields as search fields to make a search for those including the input information from respective candidates in these search fields. Then, if there is any corresponding one, the input information prediction means 105 may acquire, as a predictive conversion candidate, the content of a record in the record position of the type-specific field determined to be the estimation result.

In the example depicted in FIG. 35, since two records correspond in the “field B,” “yamamoto@sl.aaa.com” and “yamamoto@dev.aaa.com” as the contents of records in the “field C” corresponding to these two records are acquired as predictive conversion candidates.

Then, the input information prediction means 105 acquires scores of the acquired records based on the input log, and ranks and presents the predictive conversion candidates based on the obtained scores. When no record-specific scores are calculated in the type-of-input information estimation processing, the input information prediction means 105 may calculate the scores. In the case of the example, the input information prediction means 105 may count how many input log records that match the contents of the acquired records and are effective are contained, and set them as scores. Alternatively, the input information prediction means 105 may add the level of effectiveness of each of the input log records that match the contents of the acquired records, and sets it as each of the scores. Then, the input information prediction means 105 may rank the predictive conversion candidates according to the scores based on the matching degrees with the input log and to which the levels of effectiveness are added. In the example depicted in FIG. 35, “yamamoto@sl.aaa.com” having the highest score as the first predictive conversion candidate and “yamamoto@dev.aaa.com” having the second highest score as the second predictive conversion candidate are present.

Thus, even in the example, only input of “Yamamoto” leads to presenting, as candidates, information related thereto and in a format that meets the type of information to be input to the input box. Since this not only allows the user to enter right information, but also can save the effort of the user to enter the information, the user is allowed to enter right information easily. Further, in the example, since the candidates are ranked and presented based on the scores of matching degrees with the input log in consideration of the levels of effectiveness of the log, conversion candidates can be presented in order of more optimized ranking such as to prevent information wrongly input in the past from being presented in a high ranking.

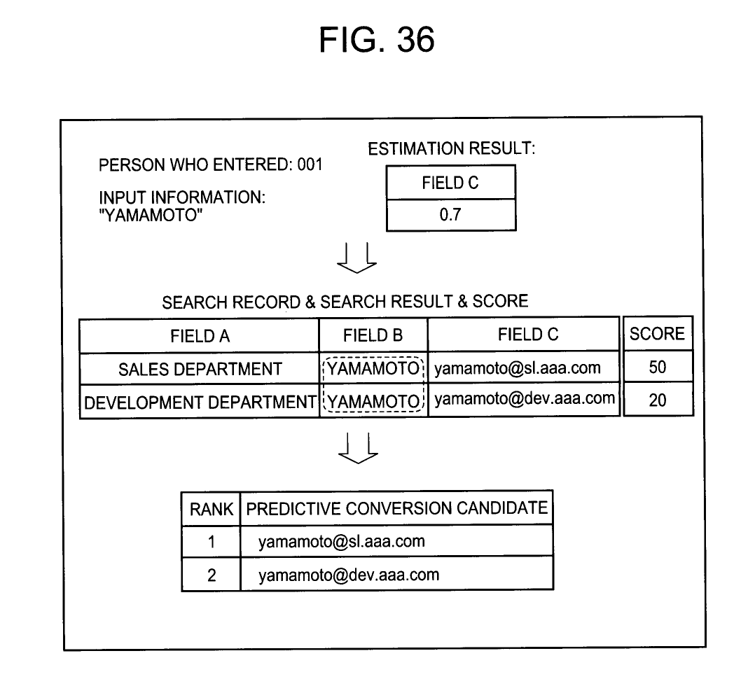

FIG. 36 is an explanatory diagram depicting still another example of prediction processing by the input information prediction means 105. For example, it is assumed that the input information prediction means 105 has obtained the “field C” of the type-specific correct answer input DB 102 depicted in FIG. 9 as the estimation result of the type of information to be input to the target input box. Note that the type-specific correct answer input DB 102 depicted in FIG. 9 has the “field A” and the “field B” as well as the “field C,” and these type-specific fields have different entries but the respective records thereof are associated with one another. In the example, it is also assumed that the information depicted in FIG. 14(b) is registered as the input log. In other words, it is assumed that an input log with information on persons who entered data is registered.

Suppose here that input of “Yamamoto” is accepted as new input information to the target input box. In such a case, the input information prediction means 105 may set all the type-specific fields as search fields to make a search for those including the input information from respective candidates in these search fields. Then, if there is any corresponding one, the input information prediction means 105 may acquire, as a predictive conversion candidate, the content of a record in the record position of the type-specific field determined to be the estimation result.

In the example depicted in FIG. 35, since two records correspond in the “field B,” “yamamoto@sl.aaa.com” and “yamamoto@dev.aaa.com” as the contents of records in the “field C” corresponding to these two records are acquired as predictive conversion candidates.

Then, the input information prediction means 105 acquires scores of the acquired records based on the input log, and ranks and presents the predictive conversion candidates based on the obtained scores. When no record-specific scores are calculated in the type-of-input information estimation processing, the input information prediction means 105 may calculate the scores. In the case of the example, the input information prediction means 105 may count how many log records as input log records that match the content of each of the acquired records and of the same user as the person who entered this input information are contained, and set it as each of the scores. The input information prediction means 105 may rank the predictive conversion candidates according to the scores based on the matching degrees with the input log of the same user. In the example depicted in FIG. 36, “yamamoto@sl.aaa.com” having the highest score as the first predictive conversion candidate and “yamamoto@dev.aaa.com” having the second highest score as the second predictive conversion candidate are present.

Thus, even in the example, only input of “Yamamoto” leads to presenting, as conversion candidates, information related thereto and in a format that meets the type of information to be input to the input box. This not only allows the user to enter right information, but also can save the effort of the user to enter the information. Further, in the example, the candidates are ranked and presented based on scores corresponding to the matching degrees with the past input log of the user who entered information this time. Therefore, the conversion candidates can be presented in order of more optimized ranking such as to present, in a high ranking, a candidate likely to be entered by the user.

Like an IME (Input Method Editor), the input information prediction means 105 may alter an input content to a predictive conversion candidate highest in ranking on the user's way to entering the content, rather than displaying a list of predictive conversion candidates, to process the input content as a pending conversion candidate. Further, the input information prediction means 105 may generate and output an alert message saying “Did you want to enter oo?” using a conversion candidate high in score after the user enters the content.

When the input information prediction means 105 is operated as the IME, the input information prediction means 105 may be a web IME that responds in an input box, or may be an IME installed and run on a client terminal. In such a case, the input information prediction means 105 may recommend a predictive conversion candidate in consideration of both a user-specific IME history and a history of the input box. As the way to recommend, AND or OR of both may be taken. Further, for example, high priority may be given to the user-specific IME history, high priority may be given to the history of the input box, or the priority of either one may be raised. In addition, the input log may be stored on a system side (server side), or stored on a user side (client side).

As described above, according to the exemplary embodiment, even without specifying, in advance, the type of data that can be input, the input information prediction means 105 predicts correct input using the estimation result by the type estimation means 103. Therefore, since the estimation result can be presented or automatically altered, or an alert message can be output, accurate input information can be obtained.

Further, in the example depicted in FIG. 28, the input information prediction means 105 is added to the configuration of the first exemplary embodiment. However, for example, the input information prediction means 105 may be added to the configuration of the second exemplary embodiment. In such a case, the input support system may perform error detection and presentation of a predictive conversion candidate at the same time, or may selectively perform only either one of the functions.

While the present invention has been described with reference to the aforementioned exemplary embodiments and examples, the present invention is not limited to the aforementioned exemplary embodiments and examples. Various changes that can be understood by those skilled in the art within the scope of the present invention can be made to the configurations and details of the present invention.

This application is based upon and claims the benefit of priority from Japanese patent application No. 2013-009571, filed on Jan. 22, 2013, the disclosure of which is incorporated herein in its entirety by reference.

### INDUSTRIAL APPLICABILITY

The present invention can be suitably applied to a system in which various input boxes are provided on a user interface.

### REFERENCE SIGNS LIST

101 input log storage means
102 type-specific correct answer input storage means (type-specific correct answer input DB)
103 type estimation means
104 error detection means
105 input information prediction means

What is claimed is:

1. An input support system comprising:
an input log storage unit which stores, as an input log, information input to a target input box in the past;
a type-specific correct answer input storage unit which stores information indicative of correct input for each type of information; and
a type estimation unit which estimates to which type-specific field, as a field for each type stored in the type-specific correct answer input storage unit the type of information to be input to the input box corresponds, based on the input log stored in the input log storage unit and information indicative of type-specific correct input stored in the type-specific correct answer input storage unit.

2. The input support system according to claim 1, wherein the type-specific correct answer input storage unit has two or more type-specific fields in which pieces of information having identical entries but different in description format are set as different types of information.

3. The input support system according to claim 1, wherein the type-specific correct answer input storage unit has two or more type-specific fields in which pieces of information having different entries are set as different types of information.

4. The input support system according to claim 1, wherein the type estimation unit determines, for each type-specific field stored in the type-specific correct answer input storage unit, whether each piece of past input information contained in the input log matches correct input listed in the type-specific field, calculates the number of matched log records as the number of matched pieces of input information, and estimates, as a type of information to be input to the target input box, a type-specific field whose matching degree with the input log based on the calculated number of matched log records is larger than or equal to a predetermined threshold, or takes a largest value.

5. The input support system according to claim 4, wherein
the input log storage unit stores an input log with a level of effectiveness given to each piece of information input in the past, and
the type estimation unit uses the level of effectiveness as a weight per log record to calculate a matching degree with the input log for each type-specific field.

6. The input support system according to claim 4, wherein
two or more type-specific fields, where pieces of information different in granularity are set as different types of information, are registered as a concatenated field in the type-specific correct answer input storage unit, and
the type estimation unit handles type-specific fields registered as the concatenated field as one concatenated type-specific field to calculate a matching degree with the input log.

7. The input support system according to claim 1, wherein
the type-specific correct answer input storage unit stores a list of candidates for information as information indicative of correct input, and
the type estimation unit identifies to which candidate past input information contained in the input log corresponds, and based on the result, gives a score to each candidate of a type-specific field determined to be an estimation result.

8. The input support system according to claim 1, wherein
the type-specific correct answer input storage unit stores a list of candidates for information as information indicative of correct input,
the input log storage unit stores an input log with information indicative of a user who entered each piece of information input in the past, and
the type estimation unit identifies to which
candidate input information entered by a specified user among past input information contained in the input log corresponds, and based on the result, gives a score to each candidate of a type-specific field determined to be an estimation result.

9. The input support system according to claim 1, wherein
the type-specific correct answer input storage unit includes a list of candidates for information as information indicative of correct input, and
the type estimation unit identifies to which candidate past input information contained in the input log corresponds, and based on the result, determines a priority element from the list of candidates of a type-specific field determined to be an estimation result.

10. The input support system according to claim 1, further comprising
an error detection unit which makes an error determination of information newly input to the target input box based on the estimation result by the type estimation unit, and information indicative of type-specific correct input stored in the type-specific correct answer input storage unit to detect an error.

11. The input support system according to claim 10, wherein the error detection unit determines whether the information newly input to the target input box matches correct input listed in a type-specific field determined by the type estimation unit to be an estimation result, and if not match, detects an error.

12. The input support system according to claim 10, wherein even when the information newly input to the target input box does not match the correct input listed in the type-specific field determined by the type estimation unit to be the estimation result, if the information matches correct input listed in another type-specific field, the error detection unit will detect an error and output a message indicating that the type of input information is different.

13. The input support system according to claim 10, wherein
the type-specific correct answer input storage unit stores a list of candidates for information as information indicative of correct input, and
even when a priority element is determined for candidates contained in the type-specific field determined to be the estimation result, if the information newly input to the target input box does not contain the priority element, the error detection unit will output a message for alerting a user to a potential input error.

14. The input support system according to claim 1, further comprising
an input information prediction unit predicts and outputs information to be input to the input box from the information newly input to the target input box based on the estimation result by the type estimation unit, and information indicative of type-specific correct input stored in the type-specific correct answer input storage unit.

15. The input support system according to claim 14, wherein
the type-specific correct answer input storage unit stores a list of candidates for information as information indicative of correct input, and
the input information prediction unit acquires a candidate containing the information newly input to the target input box from the list of candidates listed in the type-specific field determined by the type estimation unit to be the estimation result, and outputs the acquired candidate as a prediction result.

16. The input support system according to claim 15, wherein
the type-specific correct answer input storage unit stores a list of candidates for information as information indicative of correct input, and
when a score is given to each candidate in the type-specific field determined to be the estimation result, the input information prediction unit ranks and outputs the acquired candidate based on the score.

17. The input support system according to claim 15, wherein
the type-specific correct answer input storage unit stores a list of candidates for information as information indicative of correct input, where respective candidates of respective type-specific fields are associated with each other between records, and
when a candidate that matches the information newly input to the target input box is contained in the list of candidates listed in any type-specific field other than the type-specific field determined by the type estimation unit to be the estimation result, the input information prediction unit acquires an element of the type-specific field determined to be the estimation result in a candidate record, and outputs the acquired candidate as a prediction result.

18. An input support method comprising:
causing an input log storage unit to store, as an input log, information input to a target input box in the past;
causing a type-specific correct answer input storage unit to store information indicative of correct input for each type of information; and
causing an information processing apparatus to estimate to which type-specific field, as a field for each type stored in the type-specific correct answer input storage unit, the type of information to be input to the input box corresponds, based on the input log stored in the input log storage unit and information indicative of type-specific correct input stored in the type-specific correct answer input storage unit.

19. The input support method according to claim 18, wherein the information processing apparatus makes an error determination of information newly input to the target input box based on the estimation result and information indicative of type-specific correct input stored in the type-specific correct answer input storage unit to detect an error.

20. The input support method according to claim 18, wherein the information processing apparatus predicts and outputs information to be input to the input box from the information newly input to the target input box based on the estimation result and information indicative of type-specific correct input stored in the type-specific correct answer input storage unit.

21. A non-transitory computer readable information recording medium storing an input support program applied to an information processing apparatus accessible to an input log storage unit for storing, as an input log, information input to a target input box in the past, and a type-specific correct answer input storage unit for storing information indicative of correct input for each type of information, when executed by a processor, the program performs a method for:
estimating to which type-specific field, as a field for each type stored in the type-specific correct answer input storage unit, the type of information to be input to the input box corresponds, based on the input log stored in the input log storage unit and information indicative of type-specific correct input stored in the type-specific correct answer input storage unit.

22. The non-transitory computer readable information recording medium according to claim 21, further comprising: making an error determination of information newly input to the target input box based on the estimation result and information indicative of type-specific correct input stored in the type-specific correct answer input storage unit in order to detect an error.

23. The non-transitory computer readable information recording medium according to claim 21, comprising: predicting and outputting information to be input to the input box from the information newly input to the target input box based on the estimation result and information indicative of type-specific correct input stored in the type-specific correct answer input storage unit.
